(19) United States
(12) Patent Application Publication
(10) Pub. No.: US 2024/0344780 A1
(43) Pub. Date: Oct. 17, 2024

(54) HEAT STORAGE POWER GENERATION SYSTEM AND HEAT STORAGE APPARATUS

(71) Applicants: TOSHIBA ENERGY SYSTEMS & SOLUTIONS CORPORATION, Kawasaki-shi (JP); Chubu Electric Power Company, Incorporated, Nagoya-shi (JP)

(72) Inventors: Hiromutsu MIKI, Yokohama Kanagawa (JP); Naoya MATSUDA, Nagoya Aichi (JP); Chikako IWAKI, Shinagawa Tokyo (JP); Norio OIWA, Nagoya Aichi (JP); Tomohiro TEJIMA, Kita Tokyo (JP); Yukitoshi OOTA, Yokohama Kanagawa (JP); Yoshihiro IWATA, Kawasaki Kanagawa (JP); Naoji KASHIMA, Nagoya Aichi (JP)

(21) Appl. No.: 18/756,081

(22) Filed: Jun. 27, 2024

Related U.S. Application Data
(63) Continuation of application No. PCT/JP2023/011526, filed on Mar. 23, 2023.

(30) Foreign Application Priority Data
Mar. 29, 2022 (JP) 2022-054078

(51) Int. Cl. F28D 20/00

(52) U.S. Cl. CPC F28D 20/0056; F28D 2020/0013; F28D 2020/006; F28D 2020/0073; F28D 2020/0078

(57) ABSTRACT

In one embodiment, a heat storage power generation system includes a heat storage including a heat storage material that stores heat, and configured to heat a heat transmitting fluid by the heat stored in the heat storage material. The system further includes a first heater provided in the heat storage, and configured to heat the heat storage material. The system further includes a power generator that generates power using the fluid heated by the heat storage. The heat storage includes an inlet to which the fluid is supplied when storing the heat in the heat storage material, and an outlet that discharges the fluid when storing the heat in the heat storage material. The first heater includes one or more heat generation sources disposed closer to an inlet side of the inlet and the outlet, and heats the heat storage material by heat generated from the heat generation sources.

### CROSS REFERENCE TO RELATED APPLICATION

This application is a bypass continuation of International Patent Application No. PCT/JP2023/011526, filed on Mar. 23, 2023, which claims the benefit of priority from the prior Japanese Patent Application No. 2022-054078, filed on Mar. 29, 2022. The entire contents of these applications are incorporated herein by reference.

### FIELD

Embodiments described herein relate to a heat storage power generation system and a heat storage apparatus.

### BACKGROUND

To date, various heat storage power generation systems have been proposed. In general, a heat storage power generation system includes a heat storage including a heat storage material, a heater that heats the heat storage material, and a power generator that generates power using heat stored in the heat storage material.

For example, there has been proposed a technique for managing the amount of energy for heating the heat storage material to a certain value by measuring the temperature of a heat transmitting fluid at the inlet and the outlet of the heater when the heat storage is operated in a heat storing mode. Further, there has been proposed a technique in which the power generator generates power using a steam turbine cycle when the heat storage is operated in a heat dissipating mode. Further, various proposals have also been made regarding the transfer of heat via the heat transmitting fluid, the use of thermal gradient in the heat storage, the arrangement of the heat storage material, and the like.

In the heat storing mode, the heat storage material in the heat storage is heated by some means (e.g., a high-temperature heat transmitting fluid). Then, due to a rise in the temperature of the heat storage material, energy is stored in the heat storage. The high-temperature heat transmitting fluid is produced, for example, by power generated using natural energy. This power is, for example, surplus power that exceeds the power required by a power system.

In the heat dissipating mode, the heat storage material in the heat storage dissipates heat to some means (e.g., a low-temperature heat transmitting fluid). The low-temperature heat transmitting fluid is heated by receiving thermal energy from the heat storage material. As a result, the thermal energy in the heat storage material reduces. The heat transmitting fluid heated in the heat storage is sent to the power generator, and supplies thermal energy to the steam turbine cycle in the power generator. The power generator generates power using this thermal energy.

### BRIEF DESCRIPTION OF THE DRAWINGS

FIG. 1 is a schematic diagram showing a configuration of a heat storage power generation system of a first embodiment;

FIGS. 2A and 2B are a perspective view and a cross-sectional view showing an example configuration of a heat storage 2 and the like of the first embodiment;

FIGS. 3A to 3C are perspective views showing another example configuration of the heat storage 2 and the like of the first embodiment;

FIGS. 4A and 4B are a perspective view and a cross-sectional view showing another example configuration of the heat storage 2 and the like of the first embodiment;

FIGS. 5A and 5B are a plan view and a cross-sectional view showing another example configuration of the heat storage 2 and the like of the first embodiment;

FIG. 6 is a graph for explaining operation of the heat storage power generation system of the first embodiment;

FIG. 7 is another graph for explaining operation of the heat storage power generation system of the first embodiment;

FIG. 8 is a diagram showing an example configuration of an electric circuit of the heat storage power generation system of the first embodiment;

FIG. 9 is a diagram showing another example configuration of the electric circuit of the heat storage power generation system of the first embodiment;

FIG. 10 is a schematic diagram showing a configuration of a heat storage power generation system of a second embodiment;

FIG. 11 is a schematic diagram showing a configuration of a heat storage power generation system of a third embodiment;

FIG. 12 is a graph for explaining operation of the heat storage 2 of the third embodiment;

FIGS. 13A and 13B are other graphs for explaining operation of the heat storage 2 of the third embodiment;

FIG. 14 is a diagram showing an example configuration of the electric circuit of the heat storage power generation system of the third embodiment;

FIG. 15 is a diagram showing another example configuration of the electric circuit of the heat storage power generation system of the third embodiment;

FIG. 16 is a schematic diagram showing a configuration of a heat storage power generation system of a fourth embodiment;

FIG. 17 is a schematic diagram showing a configuration of a heat storage power generation system of a fifth embodiment;

FIG. 18 is a schematic diagram for explaining a heat storing mode of the fifth embodiment;

FIG. 19 is a schematic diagram for explaining a heat dissipating mode of the fifth embodiment;

FIG. 20 is a schematic diagram showing a configuration of a heat storage power generation system of a sixth embodiment;

FIG. 21 is a schematic diagram for explaining a heat storing mode of the sixth embodiment; and

FIG. 22 is a schematic diagram for explaining a heat dissipating mode of the sixth embodiment.

### DETAILED DESCRIPTION

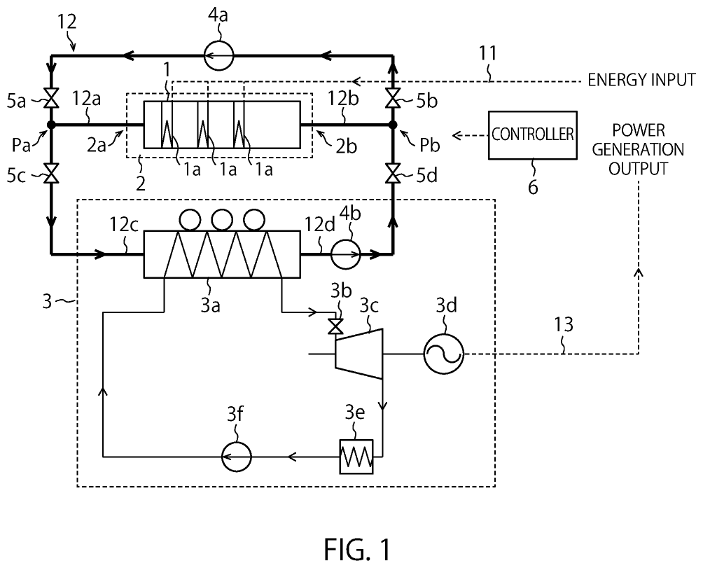

Embodiments will now be explained with reference to the accompanying drawings. In FIGS. 1-22, the same components are given the same reference numerals, and duplicate description is omitted.

In the above-described heat storage power generation system, the heater heats the heat transmitting fluid, and the heat transmitting fluid heated by the heater heats the heat storage material in the heat storage. As a result, heat is stored in the heat storage material and used for power generation. In this case, in order to increase the heat storage density of the heat storage, it is necessary to raise the temperature of the heat storage material and the temperature of piping for the heat storage to high temperature, but this causes problems such as an increase in heat loss and an increase in cost.

In one embodiment, a heat storage power generation system includes a heat storage including a heat storage material that stores heat, and configured to heat a heat transmitting fluid by the heat stored in the heat storage material. The system further includes a first heater provided in the heat storage, and configured to heat the heat storage material. The system further includes a power generator configured to generate power using the heat transmitting fluid heated by the heat storage. The heat storage includes an inlet to which the heat transmitting fluid is supplied when storing the heat in the heat storage material, and an outlet that discharges the heat transmitting fluid when storing the heat in the heat storage material. The first heater includes one or more heat generation sources disposed closer to an inlet side of the inlet and the outlet, and heats the heat storage material by heat generated from the heat generation sources.

### First Embodiment

### [A] Overalls of Heat Storage Power Generation System

FIG. 1 is a schematic diagram showing a configuration of a heat storage power generation system of a first embodiment.

The heat storage power generation system of this embodiment includes a heater 1, a heat storage 2, a power generator 3, a first heat transferring unit 4a, a second heat transferring unit 4b, flow path switches 5a, 5b, 5c, and 5d, and a controller 6. The heater 1 is an example of the first heater. The flow path switches 5a and 5b are examples of a first flow path switch. The flow path switches 5c and 5d are examples of a second flow path switch. Further, the heater 1 and the heat storage 2 in the heat storage power generation system of this embodiment are an example of a heat storage apparatus.

The heater 1 includes one or more heat generation sources 1a. The heat storage 2 includes an inlet 2a and an outlet 2b. The power generator 3 includes a heat exchanger 3a, a steam valve 3b, a steam turbine 3c, a steam turbine generator 3d, a condenser 3e, and a water feeding pump 3f.

### [A-1] Heater 1

FIG. 1 shows energy input 11 to the heater 1. The heater 1 of this embodiment receives power as the energy input 11, and converts the power into heat by the heat generation sources 1a. The heat generation sources 1a are, for example, radiant tube type heaters. The heat generation sources 1a may be something that converts energy other than power into heat.

The heater 1 is installed in the heat storage 2 and heats the heat storage material in the heat storage 2. Specifically, the heater 1 of this embodiment heats the heat storage material by radiant heat generated from the heat generation sources 1a. That is, the heater 1 of this embodiment heats the heat storage material by radiant heat transmission. The heater 1 of this embodiment may further heat the heat transmitting fluid 12 flowing through the heat storage 2 by heat generated from the heat generation sources 1a, and heat the heat storage material by heat transport via the heat transmitting fluid 12. That is, the heater 1 of this embodiment may heat the heat storage material by radiant heat transmission and at the same time by convection heat transmission.

FIG. 1 shows one or more heat generation sources 1a of the heater 1 of this embodiment. These heat generation sources 1a are disposed closer to the inlet 2a side of the inlet 2a and the outlet 2b in the heat storage 2. That is, an average distance between these heat generation sources 1a and the inlet 2a is shorter than an average distance between these heat generation sources 1a and the outlet 2b. Therefore, these heat generation sources 1a are not evenly disposed in the heat storage 2, but are unevenly disposed in the heat storage 2 so as to be closer to the inlet 2a side.

### [A-2] Heat Storage 2

The heat storage 2 includes therein a heat storage material (not shown). The heat storage material is, for example, a plurality of crushed stones obtained by crushing rocks. The heat storage 2 stores heat generated from the heat generation sources 1a in the heat storage material, and heats the heat transmitting fluid 12 flowing through the heat storage 2 by the heat stored in the heat storage material. The heat storage 2 may include a heat storage material other than crushed stones (e.g., sand, molten salt, concrete, brick, alloy PCM (Phase Change Material), or the like). The heat storage 2 of this embodiment includes heat generation sources 1a installed between the crushed stones and one or more frames (not shown) for installing the heat generation sources 1a between the crushed stones. The heat storage 2 of this embodiment is operated in a heat storing mode or a heat dissipating mode.

In the heat storing mode, the heat transmitting fluid 12 circulates in the flow path between the first heat transferring unit 4a, the flow path switch 5a, the heat storage 2, and the flow path switch 5b. FIG. 1 shows a point Pa between the flow path switch 5a and the heat storage 2, and a point Pb between the heat storage 2 and the flow path switch 5b.

In the heat dissipating mode, the heat transmitting fluid 12 circulates in the flow path between the second heat transferring unit 4b, the flow path switch 5d, the heat storage 2, the flow path switch 5c, and the heat exchanger 3a. The point Pb is located between the flow path switch 5d and the heat storage 2, and the point Pa is located between the heat storage 2 and the flow path switch 5c.

FIG. 1 further shows heat transmitting fluids 12a, 12b, 12c, and 12d as the heat transmitting fluid 12. Hereinafter, the flow of the heat transmitting fluid 12 in the heat storing mode and the heat dissipating mode will be described focusing on the heat transmitting fluids 12a-12d.

In the heat storing mode, the heat transmitting fluid 12a flows from the flow path switch 5a to the inlet 2a of the heat storage 2 via the point Pa, and enters the heat storage 2. In the heat storage 2, the heat storage material is heated by radiation heat transmission from the heat generation sources 1a and convection heat transmission from the heat transmitting fluid 12a, so that the temperature of the heat storage material rises. The heat transmitting fluid 12a, after its temperature has changed in the heat storage 2, becomes the heat transmitting fluid 12b and is discharged outside the heat storage 2. The heat transmitting fluid 12b flows from the outlet 2b of the heat storage 2 to the flow path switch 5b via the point Pb, and passes through the first heat transferring unit 4a. FIG. 1 represents the heat transmitting fluid 12 flowing toward the first heat transferring unit 4a as “heat transmitting fluid 12b”, and represents the heat transmitting fluid 12 having passed through the first heat transferring unit 4a as “heat transmitting fluid 12a”. This heat transmitting fluid 12a flows again toward the flow path switch 5a. In this way, in the heat storing mode, energy is stored in the heat storage 2 due to the rise in the temperature of the heat storage material in the heat storage 2.

In the heat dissipating mode, the low-temperature heat transmitting fluid 12d flows from the heat exchanger 3a to the outlet 2b of the heat storage 2 via the second heat transferring unit 4b, the flow path switch 5d, and the point Pb, and enters the heat storage 2. In the heat storage 2, the heat of the heat storage material is taken away by the heat transmitting fluid 12d (heat dissipation), and the temperature of the heat storage material decreases. On the other hand, the heat transmitting fluid 12d is increased in temperature to become the high-temperature heat transmitting fluid 12c and is discharged outside the heat storage 2. The heat transmitting fluid 12c flows from the inlet 2a of the heat storage 2 to the flow path switch 5c via the point Pa, and passes through the heat exchanger 3a. At this time, the heat transmitting fluid 12c is decreased in temperature due to heat exchange to return to the low-temperature heat transmitting fluid 12d. This heat transmitting fluid 12d flows again toward the second heat transferring unit 4b. In this way, in the heat dissipating mode, the temperature of the heat storage material decreases by releasing energy from the heat storage material in the heat storage 2.

In the heat storage 2 in the heat storing mode, the region close to the inlet 2a is the high temperature side, and the region close to the outlet 2b is the low temperature side. As described above, the heat generation sources 1a of this embodiment are disposed closer to the inlet 2a side in the heat storage 2. This makes it possible to suppress the even heating of the heat storage 2 in the heat storing mode. The advantage of unevenly heating the heat storage 2 in the heat storing mode will be described later.

The heat transmitting fluid 12 may flow so as not to circulate in the heat storage power generation system instead of flowing so as to circulate in the heat storage power generation system. Examples of such heat storage power generation systems will be described later.

### [A-3] Power Generator 3

The power generator 3 generates power using heat of the high-temperature heat transmitting fluid 12c. The power generator 3 of this embodiment generates power using a steam turbine cycle. Specifically, the heat exchanger 3a changes water to steam by heat exchange between the heat transmitting fluid 12c and water. This steam is supplied to the steam turbine 3c via the steam valve 3b and drives the steam turbine 3c. As a result, the steam turbine generator 3d connected to the steam turbine 3c is driven, and the steam turbine generator 3d generates power. FIG. 1 shows power generation output 13 from the steam turbine generator 3d. The steam discharged from the steam turbine 3c is returned to water by the condenser 3e. This water is supplied to the heat exchanger 3a again by the water feeding pump 3f.

For example, the power generator 3 performs thermal power generation such as coal boiler power generation and LNG gas turbine combined cycle power generation. However, the power generator 3 may generate power using a scheme different from these schemes. Further, the heat storage power generation system of this embodiment may be a retrofit in which the heater 1 is newly (unoriginally) installed in the heat storage power generation system, the heat storage 2 is newly (unoriginally) installed in the heat storage power generation system, and the power generator 3 is originally installed in the heat storage power generation system. This makes it possible to convert a mechanism that generates steam for the power generator 3 by heat of a thermal power generation facility that emits CO₂ into a mechanism that generates steam for the power generator 3 by heat of a CO₂-free power generation facility. Furthermore, it is also possible to improve the economic efficiency of power generation while reducing the construction cost of the heat storage power generation system compared to the case where the power generator 3 is newly installed in the heat storage power generation system.

In general, when the power generator 3 is stopped, it takes a long time to restart the power generator 3. When the power generator 3 uses a steam turbine cycle, the time for restarting the power generator 3 becomes significantly longer if the downtime of the power generator 3 is long and the steam turbine 3c is in a cold state. Therefore, it is desirable that the heater 1 in the heat storing mode generates not only heat for storing energy in the heat storage 2 but also heat for the power generator 3 to operate with the minimum output necessary for operation in the station (islanding operation in the station). This makes it possible to continue operating the power generator 3 in the heat storing mode, that is, to maintain the power generator 3 in a standby state according to the power supply and demand.

### [A-4] First and Second Heat Transferring Units 4a and 4b

The first heat transferring unit 4a is used to convey the heat transmitting fluid 12 discharged from the outlet 2b of the heat storage 2 to the inlet 2a of the heat storage 2 again in the heat storing mode. The first heat transferring unit 4a is, for example, a blower or a pump. The first heat transferring unit 4a circulates the heat transmitting fluid 12 (12a and 12b) between the first heat transferring unit 4a, the flow path switch 5a, the point Pa, the heat storage 2, the point Pb, and the flow path switch 5b. The first heat transferring unit 4a of this embodiment may circulate the heat transmitting fluid 12 at a constant flow rate, or control the flow rate of the heat transmitting fluid 12 so that it matches a variable flow rate setting value, depending on the operation purpose.

The second heat transferring unit 4b is used to convey the heat transmitting fluid 12 discharged from the inlet 2a of the heat storage 2 to the outlet 2b of the heat storage 2 again in the heat dissipating mode. The second heat transferring unit 4b is, for example, a blower or a pump. The second heat transferring unit 4b circulates the heat transmitting fluid 12 (12c and 12d) between the second heat transferring unit 4b, the flow path switch 5d, the point Pb, the heat storage 2, the point Pa, the flow path switch 5c, and the heat exchanger 3a. The second heat transferring unit 4b of this embodiment may circulate the heat transmitting fluid 12 at a constant flow rate, or control the flow rate of the heat transmitting fluid 12 so that it matches a variable flow rate setting value, depending on the operation purpose.

[A-5] Flow Path Switches 5a-5d

The open/closed states of the flow path switches 5a-5d change according to the operation mode of the heat storage power generation system of this embodiment. The flow path switch 5 is, for example, a valve or a damper.

In the heat storing mode, the flow path switches 5a and 5b are in an open state, and the flow path switches 5c and 5d are in a closed state. This makes it possible to circulate the heat transmitting fluid 12 (12a and 12b) between the first heat transferring unit 4a, the flow path switch 5a, the point Pa, the heat storage 2, the point Pb, and the flow path switch 5b.

In the heat dissipating mode, the flow path switches 5a and 5b are in a closed state, and the flow path switches 5c and 5d are in an open state. This makes it possible to circulate the heat transmitting fluid 12 (12c and 12d) between the second heat transferring unit 4b, the flow path switch 5d, the point Pb, the heat storage 2, the point Pa, the flow path switch 5c, and the heat exchanger 3a

### [A-6] Controller 6

The controller 6 controls various operations of the heat storage power generation system of this embodiment. For example, the controller 6 switches the operation mode of the heat storage power generation system between the heat storing mode and the heat dissipating mode. Further, the controller 6 controls the heating operation of the heater 1, various operations of the heat storage 2, the power generation operation of the power generator 3, the turning on/off of the first heat transferring unit 4a and the second heat transferring unit 4b, the opening/closing of the flow path switches 5a-5d, and the like.

As described above, the heater 1 of this embodiment is provided in the heat storage 2. This embodiment makes it possible to heat the heat storage material in the heat storage 2 not only by convection heat transmission from the heat transmitting fluid 12 but also by radiant heat transmission from the heat generation sources 1a. By using not only convection heat transmission but also radiant heat transmission, it is possible to supply the required heating amount for the heat storage material even if the flow rate of the heat transmitting fluid 12 is low, and therefore it is possible to reduce the heat transmission loss in the heat transmitting fluid 12 and to avoid making the temperature in the heater 1 excessively high.

### [B] Details of Heat Storage Power Generation System

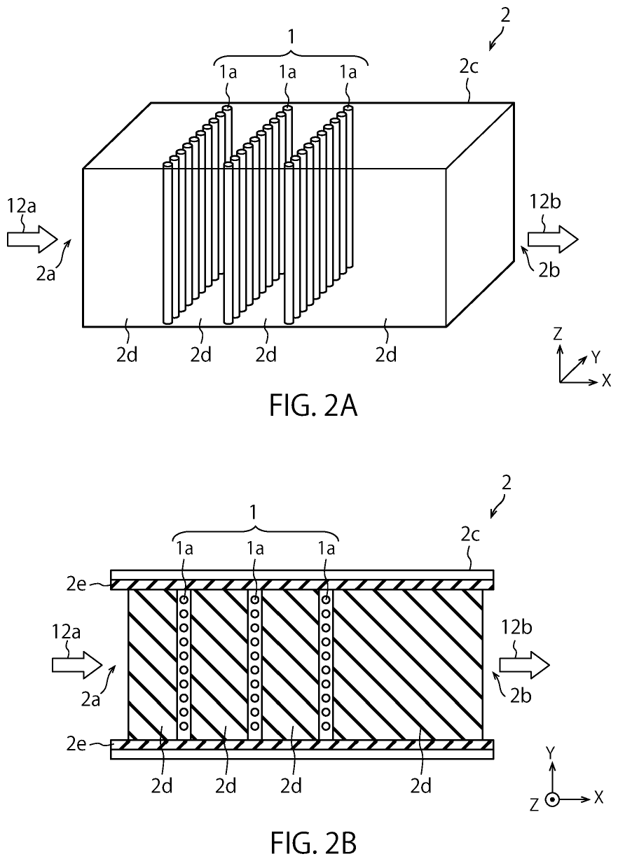

Next, further details of the heat storage power generation system of this embodiment will be described with reference to FIGS. 2A and 2B to 9.

### [B-1] FIGS. 2A and 2B

FIGS. 2A and 2B are a perspective view and a cross-sectional view showing an example configuration of the heat storage 2 and the like of the first embodiment.

FIG. 2A is a perspective view showing the heat storage 2 and the heater 1 in the heat storage 2. FIG. 2A shows the X, Y, and Z directions perpendicular to each other. In the present specification, the +Z direction is treated as the upward direction and the −Z direction is treated as the downward direction. The −Z direction may coincide with the direction of gravity or may not coincide with the direction of gravity. FIG. 2B is a cross-sectional view showing the XY cross-section of the heat storage 2 and the heater 1 shown in FIG. 2A.

In FIG. 2A, the heater 1 includes three sets of heat generation sources 1a, and each set of heat generation sources 1a includes ten heat generation sources 1a. Each heat generation source 1a is, for example, a tube-type heater that converts power into heat. Each heat generation source 1a extends parallel to the Z direction. In each set of heat generation sources 1a, the ten heat generation sources 1a are adjacent to each other in the Y direction. The three sets of heat generation sources 1a shown in FIG. 2A are adjacent to each other in the X direction. The heater 1 may include N sets of heat generation sources 1a (where N is a positive integer) other than three sets, and each set of heat generation sources 1a may include M heat generation sources 1a (where M is a positive integer) other than ten.

In FIG. 2A, the heat storage 2 includes the inlet 2a, the outlet 2b, a container 2c, and four rock layers 2d. The container 2c contains the heat generation sources 1a of the heater 1, includes the inlet 2a in the −X direction of the container 2c, and includes the outlet 2b in the +X direction of the container 2c. The heat transmitting fluid 12 in the heat storing mode is conveyed in the heat storage 2 from the inlet 2a to the outlet 2b in the +X direction. On the other hand, the heat transmitting fluid 12 in the heat dissipating mode is conveyed in the heat storage 2 from the outlet 2b to the inlet 2a in the −X direction. Each rock layer 2d corresponds to the above-described heat storage material and includes a plurality of crushed stones. The heat storage 2 alternately includes the three sets of heat generation sources 1a and the four rock layers 2d in the container 2c. In other words, the crushed stones are filled in the gaps in the container 2c. Each heat generation source 1a is connected to the container 2c via, for example, a flange or a frame. The heat storage 2 may include K rock layers 2d (where K is a positive integer) other than four.

FIG. 2A shows thirty heat generation sources 1a included in the heater 1. These heat generation sources 1a are disposed closer to the inlet 2a side of the inlet 2a and the outlet 2b in the heat storage 2. This makes it possible to suppress the even heating of the heat storage 2 in the heat storing mode.

In the heat storage 2 of FIG. 2A, the conveying direction (travel direction) of the heat transmitting fluid 12 is the +X direction, and each heat generation source 1a extends perpendicular to the conveying direction of the heat transmitting fluid 12. The conveying direction of the heat transmitting fluid 12 may be a direction other than the +X direction, and may be, for example, the +Z direction. When the heat transmitting fluid 12 is conveyed in the −Z direction, the heat diffusion effect can be enhanced by an updraft (buoyancy), and it is not necessary to give much consideration to the rigidity of the tube of each heat generation source 1a. On the other hand, when the heat transmitting fluid 12 is conveyed in a direction perpendicular to the Z direction, maintenance of the heat generation sources 1a becomes easier when the upper surface of the container 2c is a lid. In the heat storage 2 of FIG. 2A, the heat transmitting fluid 12 flows through, for example, the gaps between the heat generation sources 1a and the gaps between the crushed stones.

Each heat generation source 1a includes, for example, a tube and a heating wire in the tube. It is desirable that the materials of the tube and the heating wire are suitable materials according to the use temperature of the heat generation sources 1a. The material of the tube is, for example, a Ni-based alloy. The heating wire is, for example, a nichrome wire, a Fe—Cr alloy wire, a heating wire made of an SiC-based material, or the like. It is desirable to set the number of the heat generation sources 1a in the heater 1 in consideration of, for example, the required heat storage capacity or heat storage temperature.

In each set of heat generation sources 1a, a plurality of heat generation sources 1a may be separated from each other or may constitute a single U-shaped heater. In this case, it is desirable that this heater is configured to allow the heat transmitting fluid 12 to pass through the U-shaped portion of this heater. Further, a plurality of heat generation sources 1a belonging to different sets may constitute one U-shaped heater.

In FIG. 2B, the heat storage 2 includes the inlet 2a, the outlet 2b, the container 2c, the four rock layers 2d, and two heat insulating materials 2e. These heat insulating materials 2e are disposed on the +Y direction side of the heat generation sources 1a and the −Y direction side of the heat generation sources 1a. The heat storage 2 may further include a heat insulating material disposed on the +Z direction side of the heat generation sources 1a and a heat insulating material disposed on the −Z direction side of the heat generation sources 1a.

As described above, in the heat storage 2 of FIGS. 2A and 2B, the heat generation sources 1a extend perpendicular to the conveying direction of the heat transmitting fluid 12. This makes it possible to increase the heat transmission area of the heat generation sources 1a in the heat storage 2, and makes it possible to increase the amount of heat transmission from the heater 1 to the heat transmitting fluid 12. Further, if the output of the heat generation sources 1a is variable for each heat generation source 1a, it is possible to freely control the temperature distribution in the heat storage 2. The heater 1 and the heat storage 2 of this embodiment may have a configuration different from the configuration shown in FIGS. 2A and 2B as described later.

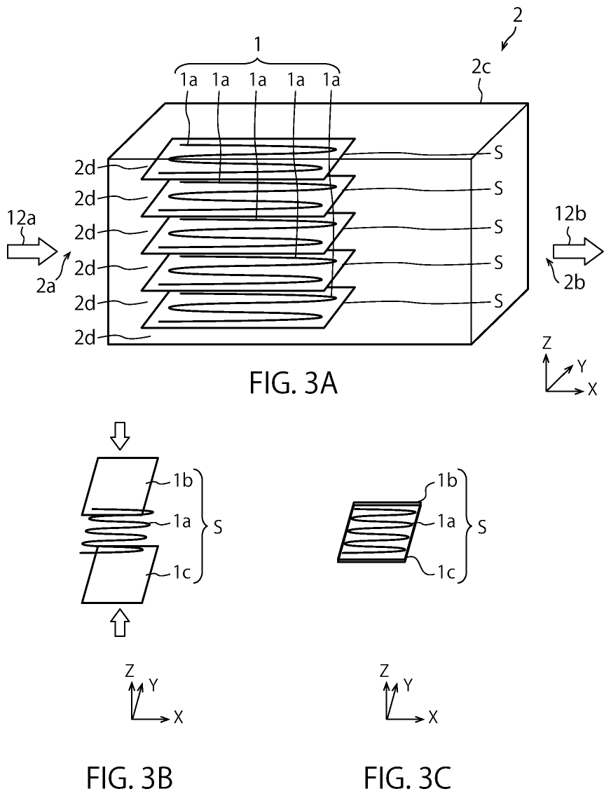

### [B-2] FIGS. 3A to 3C

FIGS. 3A to 3C are perspective views showing another example configuration of the heat storage 2 and the like of the first embodiment.

FIG. 3A is a perspective view showing the heat storage 2 and the heater 1 in the heat storage 2. In FIG. 3A, the heater 1 includes five bent heat generation sources 1a, and the heat storage 2 includes the inlet 2a, the outlet 2b, the container 2c, and six rock layers 2d. The heater 1 may include M heat generation sources 1a (where M is a positive integer) other than five. Further, the heat storage 2 may include K rock layers 2d (where K is a positive integer) other than six.

In FIG. 3A, each heat generation source 1a is, for example, a heating wire that converts power into heat. Each heat generation source 1a extends approximately parallel to the X direction except for the bent portions. The five heat generation sources 1a shown in FIG. 3A are adjacent to each other in the Z direction. Each heat generation source 1a has, for example, a corrugated shape such that a plurality of U-shaped shapes are connected.

FIG. 3A shows the five heat generation sources 1a included in the heater 1. These heat generation sources 1a are disposed closer to the inlet 2a side of the inlet 2a and the outlet 2b in the heat storage 2. This makes it possible to suppress the even heating of the heat storage 2 in the heat storing mode.

FIG. 3B shows how one heat generation source 1a is sandwiched between a first frame 1b and a second frame 1c. As a result, a flat plate type heater S including the heat generation source 1a, the first frame 1b, and the second frame 1c is formed (FIG. 3C). In FIG. 3A, the heat storage 2 alternately includes the five flat plate type heaters S and the six rock layers 2d in the container 2c. These flat plate type heaters S are disposed vertically in the Z direction in the container 2c. It is desirable that the material of the first frame 1b and the second frame 1c is a suitable material according to the use temperature of the heat generation sources 1a. The material of the first frame 1b and the second frame 1c is, for example, a Ni-based alloy.

In FIG. 3A, the heat transmitting fluid 12 in the heat storing mode is conveyed in the heat storage 2 from the inlet 2a to the outlet 2b in the +X direction, and the heat transmitting fluid 12 in the heat dissipating mode is conveyed in the heat storage 2 from the outlet 2b to the inlet 2a in the −X direction. Therefore, the conveying direction of the heat transmitting fluid 12 is the +X direction, and each heat generation source 1a extends substantially parallel to the conveying direction of the heat transmitting fluid 12 except for the bent portions. In the heat storage 2 of FIG. 3A, the heat transmitting fluid 12 flows through, for example, the gaps between the flat plate type heaters S and the gaps between crushed stones.

As described above, in the heat storage 2 of FIG. 3A, the heat generation sources 1a extend parallel to the conveying direction of the heat transmitting fluid 12. This makes it possible to uniformize the temperature distribution in the heat storage 2 by continuous heat transmission along the conveying direction of the heat transmitting fluid 12. Furthermore, it is possible to suppress the uniformization of the temperature distribution in the heat storage 2 while the heater 1 is stopped by natural convection generated in the heat storage 2 due to a difference in air density. The reason is that the heat generation sources 1a extend parallel to the conveying direction of the heat transmitting fluid 12, so that it becomes more difficult for the updraft to flow in the heat storage 2.

Each flat plate type heater S shown in FIG. 3A may be replaced with a set of heat generation sources 1a shown in FIG. 2A. That is, the heat generation sources 1a extending parallel to the conveying direction of the heat transmitting fluid 12 may be implemented using the heat generation sources 1a shown in FIG. 2A. On the other hand, each set of heat generation sources 1a shown in FIG. 2A may be replaced with one flat plate type heater S shown in FIG. 3A. That is, the heat generation sources 1a extending perpendicular to the conveying direction of the heat transmitting fluid 12 may be implemented using the heat generation sources 1a shown in FIG. 3A.

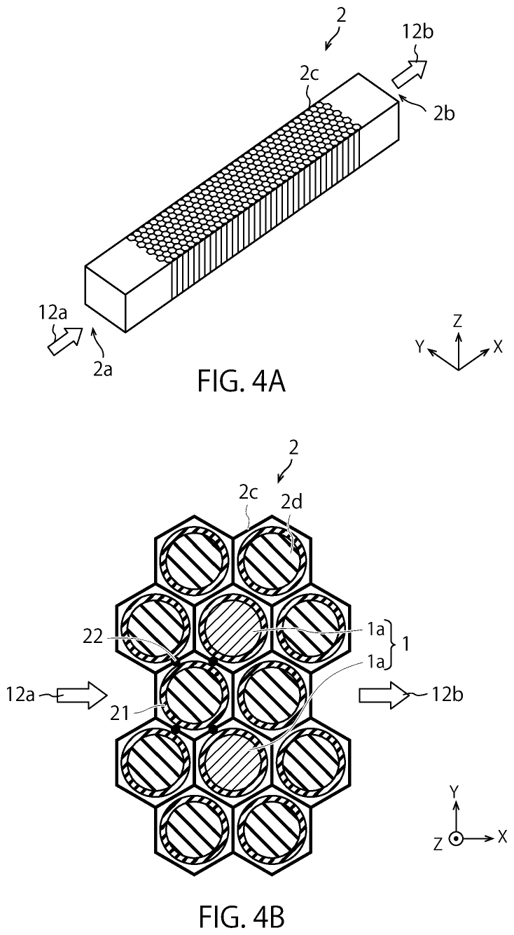

### [B-3] FIGS. 4A and 4B

FIGS. 4A and 4B are a perspective view and a cross-sectional view showing another example configuration of the heat storage 2 and the like of the first embodiment.

FIG. 4A is a perspective view showing the heat storage 2. In the heat storage 2 of FIG. 4A, the container 2c includes a case and an internal frame structure contained in the case. FIG. 4A shows the shape of the internal frame structure. The internal frame structure shown in FIG. 4A has a plurality of openings in a planar view (viewed from above), and contains the heat generation sources 1a and the rock layers 2d in these openings. The internal frame structure shown in FIG. 4A has a honeycomb structure in which the shapes of these openings are hexagonal in planar view.

FIG. 4B is a cross-sectional view showing the XY cross-section of the internal frame structure shown in FIG. 4A. The internal frame structure (the container 2c) shown in FIG. 4B contains a cylindrical container 21 in each opening in a planar view. The cylindrical container 21 is a container with a cylindrical shape extending in the Z direction. FIG. 4B shows a cylindrical container 21 (a tube) containing a heat generation source 1a (a heating wire) and a cylindrical container 21 (a tube) containing a rock layer 2d (a heat storage material). Each cylindrical container 21 is connected to the internal frame structure via one or more connecting members 22. In the internal frame structure, the heat transmitting fluid 12 flows from the inlet 2a to the outlet 2b through, for example, gaps provided in the internal frame structure and gaps between the cylindrical containers 21.

In FIG. 4B, a frame of the internal frame structure is disposed at each intersection point or the like of the honeycomb structure in a planar view. On the other hand, the heat generation sources 1a and the rock layers 2d are separated into blocks in the form of cylindrical containers 21. Each cylindrical container 21 is supported using the above-mentioned frame or the like. It is desirable that the container 2c shown in FIG. 4B has a structure that enables the rock layer 2d to be inserted and removed from the lid on the upper surface of the container 2c. In the internal frame structure shown in FIG. 4B, it is possible to adjust the distance between the rock layers 2d in different cylindrical containers 21 by increasing or decreasing the cell size of the honeycomb structure or adjusting the diameter of the cylindrical container 21. This makes it possible to reduce the pressure loss of the heat transmitting fluid 12 while maintaining the heat exchange performance of the heat storage 2.

The internal frame structure may have a structure other than the honeycomb structure. For example, the shape of each opening may be square in a planar view. The internal frame structure may have the shape of a basket having a lattice-like shape in a planar view. In this case, the container 2c may have a structure that enables the rock layer 2d to be inserted and removed together with the basket from the lid on the upper surface of the container 2c.

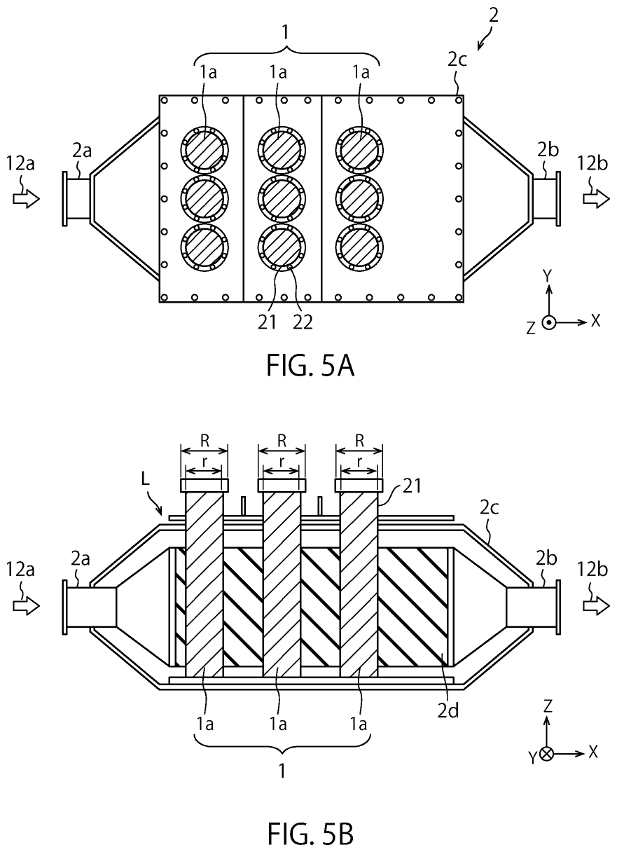

### [B-4] FIGS. 5A and 5B

FIGS. 5A and 5B are a plan view and a cross-sectional view showing another example configuration of the heat storage 2 and the like of the first embodiment.

FIG. 5A is a plan view showing the heat storage 2. In the heat storage 2 of FIG. 5A, the container 2c has a plurality of openings in a planar view, and the shape of these openings is circular in a planar view. The container 2c contains a plurality of cylindrical containers 21 in these openings, and each cylindrical container 21 contains a heat generation source 1a. Each cylindrical container 21 is connected to the container 2c via one or more connecting members 22.

FIG. 5A shows nine heat generation sources 1a of the heater 1. These heat generation sources 1a are disposed closer to the inlet 2a side of the inlet 2a and the outlet 2b in the heat storage 2. This makes it possible to suppress the even heating of the heat storage 2 in the heat storing mode.

FIG. 5B is a cross-sectional view showing the XZ cross-section of the container 2c shown in FIG. 5A. In FIG. 5B, the container 2c includes a rock layer 2d so that it surrounds each cylindrical container 21. In other words, each cylindrical container 21 is embedded in the rock layer 2d. FIG. 5B shows the diameter “r” (the outside diameter) of the cylindrical container 21 and the diameter “R” (the caliber) of the flange of the container 2c. These diameters “r” and “R” are set so that R>r, and the heat transmitting fluid 12 passes through the gap of “R−r”.

The internal frame structure of the container 2c may have the shape of a basket having a lattice-like shape in a planar view. In this case, the container 2c may have a structure that enables the rock layer 2d to be inserted and removed together with the basket from the lid L on the upper surface of the container 2c.

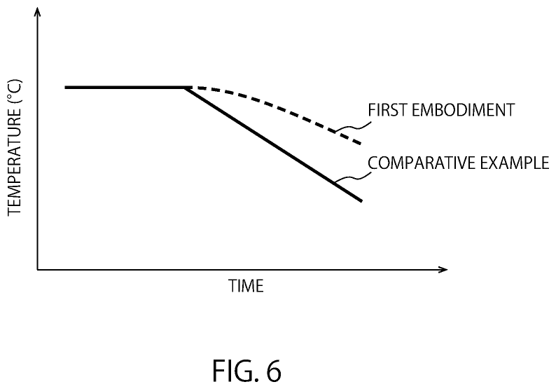

### [B-5] FIG. 6

FIG. 6 is a graph for explaining operation of the heat storage power generation system of the first embodiment.

FIG. 6 shows the temporal variation in temperature of the heat storage material around the inlet 2a of the heat storage 2 in the heat dissipating mode. FIG. 6 shows the temperature in a heat storage power generation system of a comparative example with a solid line, and shows the temperature in the heat storage power generation system of this embodiment with a dashed line. The heat storage power generation system of the comparative example includes the heater 1 outside the heat storage 2 rather than inside the heat storage 2.

Since the heat storage power generation system of this embodiment includes the heater 1 in the heat storage 2, it can heat the heat storage material by the heater 1 even in the heat dissipating mode (heat re-storage). This makes it possible to moderate the temperature drop of the heat storage material in the heat dissipating mode (FIG. 6), and makes it possible to continue the heat dissipating mode for a long time.

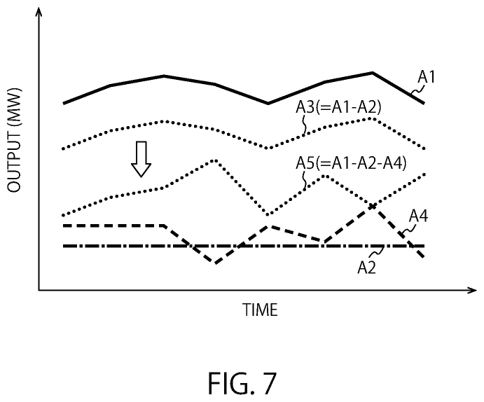

### [B-6] FIG. 7

FIG. 7 is another graph for explaining operation of the heat storage power generation system of the first embodiment.

FIG. 7 shows the temporal variation of various energies (powers) in the heat dissipating mode. A curve A1 represents power generated by the power generator 3. A curve A2 represents power used in the heat storage power generation system. A curve A3 represents power transmitted from the heat storage power generation system to the outside (e.g., power transmission and distribution companies and consumers). When power is not supplied to the heater 1 in the heat dissipating mode, the power A3 is represented by the difference between the power A1 and the power A2 (A3=A1−A2).

A curve A4 represents an example of power supplied to the heater 1 in the heat dissipating mode. In the heat storage power generation system of this embodiment, a part of the power A1 generated by the power generator 3 may be used as the power A4 supplied to the heater 1 in the heat dissipating mode. In this case, the power transmitted from the heat storage power generation system to the outside is replaced by power A5 from the power A3. The power A5 is represented by the difference between the power A1-A4 and the power A2 (A5=A1−A2−A4). This makes it possible to re-store heat in the heat dissipating mode.

This example makes it possible to increase the amount of re-stored heat by increasing the power A4 when the power A1 has a surplus, or makes it possible to reduce the amount of re-stored heat by reducing the power A4 when the power A1 is insufficient. Further, this example makes it possible to easily adjust the amount of power transmission (the power A5) according to changes in power demand. In FIG. 7, the change in the power A3 is small, while the change in the power A5 is large.

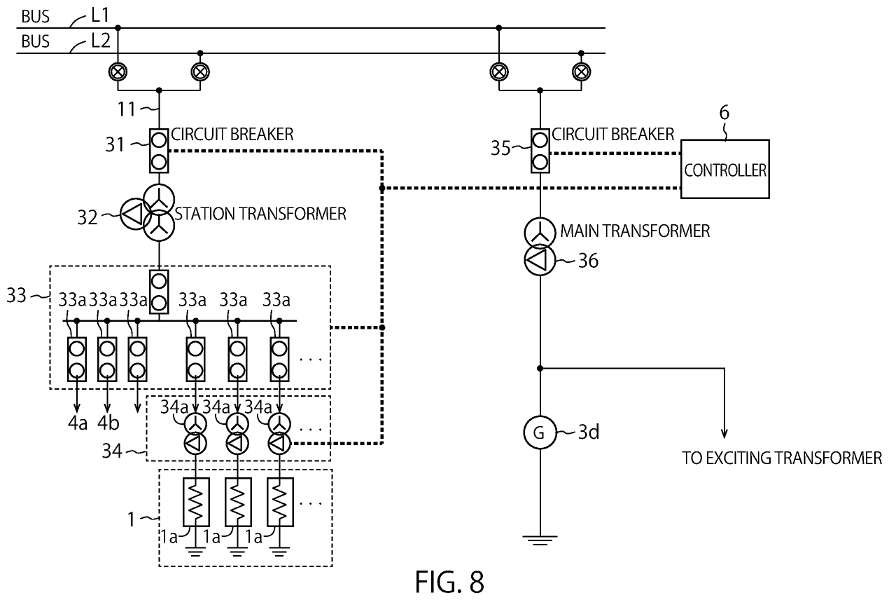

### [B-7] FIG. 8

FIG. 8 is a diagram showing an example configuration of an electric circuit of the heat storage power generation system of the first embodiment.

The electric circuit shown in FIG. 8 includes a circuit breaker 31, a station transformer 32, a power distributing unit 33, a power distributing unit 34, a circuit breaker 35, and a main transformer 36. The power distributing unit 33 includes a plurality of electric circuit switchers 33a. The power distributing unit 34 includes a plurality of transformers 34a. FIG. 8 further shows buses (power transmitting lines) L1 and L2.

In FIG. 8, the circuit breaker 31, the station transformer 32, the power distributing unit 33, and the power distributing unit 34 form a circuit for station power, and the circuit breaker 35 and the main transformer 36 form a circuit for power generation. The circuit for station power and the circuit for power generation are connected to the buses L1 and L2 by separate systems.

In the heat storing mode, the circuit breaker 31 is in an open state, and the energy input 11 from the buses L1 and L2 is transformed by the station transformer 32 and enters the power distributing unit 33. On the other hand, the circuit breaker 35 is in a closed state. The energy input 11 is further supplied to each heat generation source 1a of the heater 1 via the power distributing unit 34. Here, when the voltage of the heater 1 is lower than the voltage of the power distributing unit 33, it is necessary to install the power distributing units 33 and 34, but when the voltage of the heater 1 can be made equal to the voltage of the power distributing unit 33, only the power distributing unit 33 of the power distributing units 33 and 34 may be installed. The transformer 34a in the power distributing unit 34 is, for example, a tap changing transformer or a thyristor-controlled voltage regulator. The output amount of the heater 1 can be adjusted, for example, by opening/closing the electric circuit switchers 33a in the power distributing unit 33 or by transformation by the transformers 34a in the power distributing unit 34.

In the heat dissipating mode, the circuit breaker 35 is in an open state, and the energy output is sent to the buses L1 and L2 or the circuit for station power as described with reference to FIG. 7. At this time, transformation by the main transformer 36 is performed. In the heat dissipating mode, by setting the circuit breaker 31 to an open state in order to adjust power supply and demand and adjusting the output amount of the heater 1, it is possible to lower the minimum load of the power transmission output, to accelerate the electrical response of the power transmission output, to extend the heat dissipation operation time by inputting additional energy, etc.

The adjustment of power supply and demand is performed by the controller 6 based on the demand amount and the suppliable amount. The controller 6 of this embodiment includes a power controller that adjusts power supply and demand.

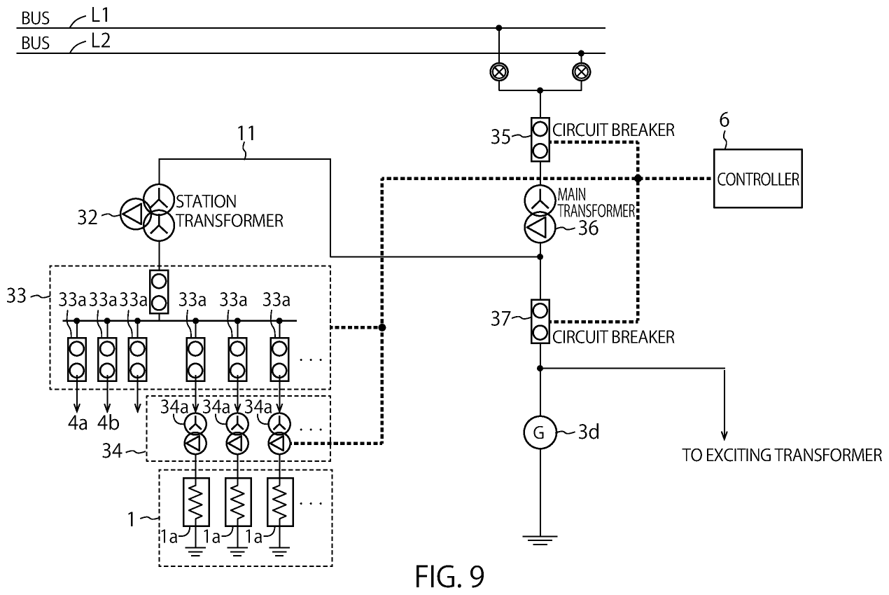

### [B-8] FIG. 9

FIG. 9 is a diagram showing another example configuration of the electric circuit of the heat storage power generation system of the first embodiment.

The electric circuit shown in FIG. 9 includes the station transformer 32, the power distributing unit 33, the power distributing unit 34, the circuit breaker 35, the main transformer 36, and a circuit breaker 37. The power distributing unit 33 includes a plurality of electric circuit switchers 33a. The power distributing unit 34 includes a plurality of transformers 34a. FIG. 9 further shows the buses L1 and L2.

In FIG. 9, the station transformer 32, the power distributing unit 33, and the power distributing unit 34 form a circuit for station power, and the circuit breaker 35, the main transformer 36, and the circuit breaker 37 form a circuit for power generation. The circuit for station power and the circuit for power generation are connected to the buses L1 and L2 by the same system. The operation of the electric circuit shown in FIG. 9 is generally the same as the operation of the electric circuit shown in FIG. 8.

### [C] FIG. 1

Next, further details of the heat storage power generation system of this embodiment will be described with reference to FIG. 1 again.

The heater 1 of this embodiment is provided in the heat storage 2. If the heater 1 is provided outside the heat storage 2, the heater 1 heats the heat storage material by convection heat transmission. In this case, it is necessary to consider the heat transmission loss in the heat transmitting fluid 12 and to set the temperature of the heat generation sources 1a (heating wires) to a higher temperature than that required at the inlet 2a of the heat storage 2. For example, when the temperature required at the inlet 2a of the heat storage 2 is 700° C., the temperature of the heat generation sources 1a must be set to 900° C. or higher, and in order to reduce the size of the heater 1, it is desirable to set the temperature of the heat generation sources 1a to 1100-1200° C. However, the heater 1 of this embodiment is provided in the heat storage 2, and can heat the heat storage material by radiation heat transmission and convection heat transmission. In general, radiant heat transmission can locally increase the temperature of the heat storage material, and convection heat transmission can uniformly increase the temperature of the heat storage material. This makes it possible to improve the heat storage efficiency in the heat storage material, and makes it possible to realize sufficient heat storage even if the temperature of the heat generation sources 1a is low. For example, when the temperature required at the inlet 2a of the heat storage 2 is 700° C., it is possible to realize sufficient heat storage even if the temperature of the heat generation sources 1a is set to 600° C., which is lower than 700° C.

Further, this embodiment makes it possible to save space for the entire heat storage power generation system by providing the heater 1 in the heat storage 2. Furthermore, by improving the heat storage efficiency in the heat storage material, it is possible to reduce the sizes of the heater 1 and the heat storage 2 themselves, which can also save space for the entire heat storage power generation system.

Further, by providing the heater 1 in the heat storage 2, this embodiment makes it possible to heat the heat storage material by the heater 1 even in the heat dissipating mode to re-store heat. This makes it possible to use the surplus generated power for re-storing heat and to deal with the shortage of generated power by reducing the amount of re-stored heat. Furthermore, as described with reference to FIG. 7, by re-storing heat in the heat dissipating mode, it is possible to easily adjust the amount of power transmission according to changes in power demand.

Further, this embodiment makes it possible to avoid the problem that it takes a long time to restart the power generator 3 by continuing to operate the power generator 3 in a standby state even in the heat storing mode.

As described above, the heater 1 of this embodiment is provided in the heat storage 2. Therefore, this embodiment makes it possible to heat the heat storage material in the heat storage 2 not only by convection heat transmission from the heat transmitting fluid 12 but also by radiant heat transmission from the heat generation sources 1a. This makes it possible to realize the heater 1 and the heat storage 2 having a suitable structure, for example, it is possible to reduce the heat transmission loss in the heat transmitting fluid 12 and to avoid making the temperature in the heater 1 excessively high.

Further, the heater 1 of this embodiment includes one or more heat generation sources 1a, and these heat generation sources 1a are disposed closer to the inlet 2a side of the inlet 2a and the outlet 2b in the heat storage 2. This makes it possible to unevenly heat the heat storage 2 in the heat storing mode.

Now, the required temperature of the heat storage material around the inlet 2a of the heat storage 2 (the required inlet temperature) is set higher than the required temperature of the heat storage material around the outlet 2b of the heat storage 2 (the required outlet temperature). This is because the temperature of the heat transmitting fluid 12 flowing through the heat storage 2 is close to the temperature of the heat storage material, so when the heat transmitting fluid 12 has high temperature when exiting the heat storage 2, the piping and equipment from the outlet 2b need to be designed to withstand high temperatures.

If the heat generation sources 1a for heating the heat storage material are evenly disposed in the heat storage 2, the heat storage 2 is heated evenly, and as a result, the heat storage material around the outlet 2b is heated to the required outlet temperature or higher before the heat storage material around the inlet 2a is heated to the required inlet temperature. As a result, if the heat storage operation is stopped when the heat storage material around the outlet 2b has reached the required outlet temperature, the average temperature of the heat storage material in the heat storage 2 decreases, and sufficient heat storage cannot be performed.

Further, even if heat storage operation is performed until the heat storage material around the inlet 2a desired to be on the high temperature side reaches the required inlet temperature in order to raise the average temperature of the heat storage material in the heat storage 2 to perform sufficient heat storage, the heat storage material around the outlet 2b becomes high in temperature in the same way as the heat storage material around the inlet 2a. Therefore, the heat storage material around the outlet 2b is heated to a temperature higher than the required outlet temperature, and the heat transmitting fluid 12 at the outlet 2b also becomes high in temperature. As a result, it is necessary to design the piping and equipment from the outlet 2b to the heater 1 so as to withstand high temperatures.

According to this embodiment, by disposing the heat generation sources 1a closer to the inlet 2a side, the heat storage material around the inlet 2a is heated to the required inlet temperature even if the heat storage operation is stopped when the heat storage material around the outlet 2b has reached the required outlet temperature. Therefore, the average temperature of the heat storage material in the heat storage 2 can be increased.

Further, even when the heat storage material around the inlet 2a desired to be on the high temperature side has reached the required inlet temperature and sufficient heat is stored in the heat storage material, the heat storage material around the outlet 2b can be suppressed to a lower temperature than the required outlet temperature. Therefore, it is not necessary to design the piping and equipment from the outlet 2b to the heater 1 so as to withstand high temperatures, and it is possible to suppress the problem when the heat storage 2 is heated evenly.

### Second Embodiment

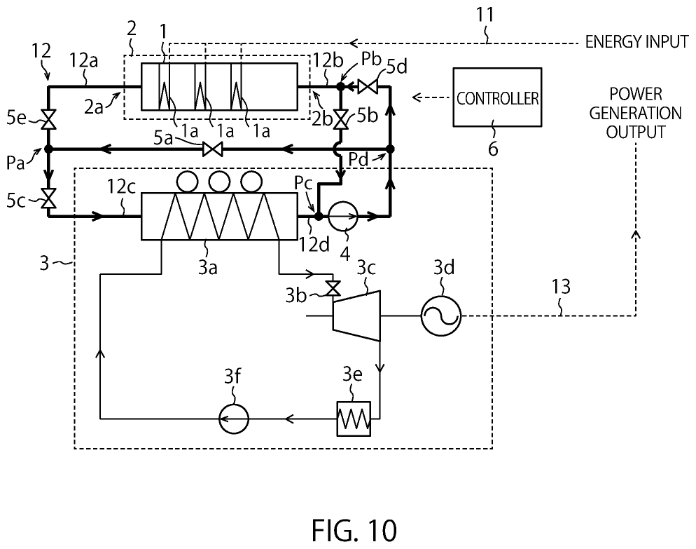

FIG. 10 is a schematic diagram showing a configuration of a heat storage power generation system of a second embodiment.

The heat storage power generation system of this embodiment includes components similar to those of the heat storage power generation system of the first embodiment. However, the heat storage power generation system of this embodiment includes a heat transferring unit 4 instead of the first heat transferring unit 4a and the second heat transferring unit 4b, and includes a flow path switch 5e in addition to the flow path switches 5a-5d. The operation of the heat transferring unit 4 and the flow path switch 5e is also controlled by the controller 6. FIG. 10 shows points Pc and Pd in addition to the points Pa and Pb.

In the heat storing mode, the heat transmitting fluid 12 circulates in the flow path between the heat transferring unit 4, the point Pd, the flow path switch 5a, the point Pa, the flow path switch 5e, the heat storage 2, the point Pb, the flow path switch 5b, and the point Pc. At this time, the flow path switches 5a, 5b, and 5e are in an open state, and the flow path switches 5c and 5d are in a closed state.

In the heat dissipating mode, the heat transmitting fluid 12 circulates in the flow path between the heat transferring unit 4, the point Pd, the flow path switch 5d, the point Pb, the heat storage 2, the flow path switch 5e, the point Pa, the flow path switch 5c, the heat exchanger 3a, and the point Pc. At this time, the flow path switches 5c, 5d, and 5e are in an open state, and the flow path switches 5a and 5b are in a closed state.

FIG. 10 further shows the heat transmitting fluids 12a-12d as the heat transmitting fluid 12. Hereinafter, the flow of the heat transmitting fluid 12 in the heat storing mode and the heat dissipating mode will be described focusing on the heat transmitting fluids 12a-12d.

In the heat storing mode, the heat transmitting fluid 12a flows from the flow path switch 5a to the inlet 2a of the heat storage 2 via the point Pa and the flow path switch 5e, and enters the heat storage 2. In the heat storage 2, the heat storage material is heated by radiation heat transmission from the heat generation sources 1a and convection heat transmission from the heat transmitting fluid 12a, so that the temperature of the heat storage material rises. The heat transmitting fluid 12a, after its temperature has changed in the heat storage 2, becomes the heat transmitting fluid 12b and is discharged outside the heat storage 2. The heat transmitting fluid 12b flows from the outlet 2b of the heat storage 2 to the point Pc via the point Pb and the flow path switch 5b, and passes through the heat transferring unit 4. FIG. 10 represents the heat transmitting fluid 12 flowing toward the heat transferring unit 4 as “heat transmitting fluid 12b”, and represents the heat transmitting fluid 12 having passed through the heat transferring unit 4 as “heat transmitting fluid 12a”. This heat transmitting fluid 12a flows again toward the flow path switch 5a via the point Pd. In this way, in the heat storing mode, energy is stored in the heat storage 2 due to the rise in the temperature of the heat storage material in the heat storage 2.

In the heat dissipating mode, the low-temperature heat transmitting fluid 12d flows from the heat exchanger 3a to the outlet 2b of the heat storage 2 via the point Pc, the heat transferring unit 4, the point Pd, the flow path switch 5d, and the point Pb, and enters the heat storage 2. In the heat storage 2, the heat of the heat storage material is taken away by the heat transmitting fluid 12d (heat dissipation), and the temperature of the heat storage material decreases. On the other hand, the heat transmitting fluid 12d is increased in temperature to become the high-temperature heat transmitting fluid 12c and is discharged outside the heat storage 2. The heat transmitting fluid 12c flows from the inlet 2a of the heat storage 2 to the flow path switch 5c via the flow path switch 5e and the point Pa, and passes through the heat exchanger 3a. At this time, the heat transmitting fluid 12c is decreased in temperature due to heat exchange to return to the low-temperature heat transmitting fluid 12d. This heat transmitting fluid 12d flows again toward the heat transferring unit 4 via the point Pc. In this way, in the heat dissipating mode, the temperature of the heat storage material decreases by releasing energy from the heat storage material in the heat storage 2.

The heat transferring unit 4 is used to convey the heat transmitting fluid 12 in the heat storing mode and the heat dissipating mode. The heat transferring unit 4 is, for example, a blower or a pump. The heat transferring unit 4 of this embodiment may circulate the heat transmitting fluid 12 at a constant flow rate, or control the flow rate of the heat transmitting fluid 12 so that it matches a variable flow rate setting value, depending on the operation purpose.

As described above, the heat storage power generation system of this embodiment includes the heat transferring unit 4 instead of the first heat transferring unit 4a and the second heat transferring unit 4b. Therefore, this embodiment makes it possible to reduce the number of heat transferring units provided in the heat storage power generation system.

The contents described with reference to FIGS. 2A and 2B to 9 can also be applied to the heat storage power generation system of this embodiment. However, the electric circuit switchers 33a in the power distributing unit 33 shown in FIG. 8 are connected to the heat transferring unit 4 instead of the first heat transferring unit 4a and the second heat transferring unit 4b. The same applies to the electric circuit switchers 33a in the power distributing unit 33 shown in FIG. 9.

### Third Embodiment

### [A] Overalls of Heat Storage Power Generation System

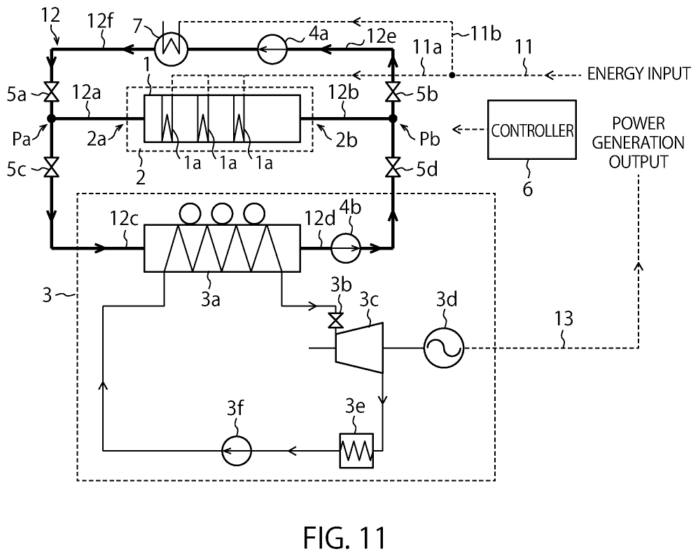

FIG. 11 is a schematic diagram showing a configuration of a heat storage power generation system of a third embodiment.

The heat storage power generation system of this embodiment includes components similar to those of the heat storage power generation system of the first embodiment. However, the heat storage power generation system of this embodiment includes a heater 7 in addition to the heater 1. The operation of the heater 7 is also controlled by the controller 6. The heater 7 is an example of a second heater.

FIG. 11 shows energy input 11a and energy input 11b separated from the energy input 11. The heater 1 of this embodiment receives power as the energy input 11a and converts this power into heat. Similarly, the heater 7 of this embodiment receives power as the energy input 11b and converts this power into heat. The heat generation source in the heater 7 is, for example, a fluid heat exchange type electric resistance heater. This heat generation source may be something that converts energy other than power into heat.

The heater 7 is installed outside the heat storage 2, heats the heat transmitting fluid 12 and supplies it to the heat storage 2. Thereby, the heat storage material in the heat storage 2 is heated by the heat transmitting fluid 12 heated by the heater 7. In this way, the heater 7 of this embodiment heats the heat storage material by convection heat transmission. The heater 7 of this embodiment may further heat the heat storage material by radiant heat transmission.

In the heat storing mode, the heat transmitting fluid 12 circulates in the flow path between the first heat transferring unit 4a, the heater 7, the flow path switch 5a, the point Pa, the heat storage 2, the point Pb, and the flow path switch 5b. At this time, the flow path switches 5a and 5b are in an open state, and the flow path switches 5c and 5d are in a closed state.

In the heat dissipating mode, the heat transmitting fluid 12 circulates in the flow path between the second heat transferring unit 4b, the flow path switch 5d, the point Pb, the heat storage 2, the point Pa, the flow path switch 5c, and the heat exchanger 3a. At this time, the flow path switches 5c and 5d are in an open state, and the flow path switches 5a and 5b are in a closed state.

FIG. 11 further shows heat transmitting fluids 12e and 12f in addition to the heat transmitting fluids 12a-12d as the heat transmitting fluid 12. Hereinafter, the flow of the heat transmitting fluid 12 in the heat storing mode and the heat dissipating mode will be described focusing on the heat transmitting fluids 12a-12f.

In the heat storing mode, the heat transmitting fluid 12a flows from the flow path switch 5a to the inlet 2a of the heat storage 2 via the point Pa, and enters the heat storage 2. In the heat storage 2, the heat storage material is heated by radiation heat transmission from the heat generation sources 1a and convection heat transmission from the heat transmitting fluid 12a, so that the temperature of the heat storage material rises. The heat transmitting fluid 12a, after its temperature has changed in the heat storage 2, becomes the heat transmitting fluid 12b and is discharged outside the heat storage 2. The heat transmitting fluid 12b flows from the outlet 2b of the heat storage 2 to the flow path switch 5b via the point Pb, and passes through the first heat transferring unit 4a and the heater 7 in order. FIG. 11 represents the heat transmitting fluid 12 flowing from the heat storage 2 to the flow path switch 5b as “heat transmitting fluid 12b”, represents the heat transmitting fluid 12 flowing from the flow path switch 5b to the heater 7 as “heat transmitting fluid 12e”, represents the heat transmitting fluid 12 flowing from the heater 7 to the flow path switch 5a as “heat transmitting fluid 12f”, and represents the heat transmitting fluid 12 flowing from the flow path switch 5a to the heat storage 2 as “heat transmitting fluid 12a”. This heat transmitting fluid 12 is heated when it passes through the heater 7, that is, when it becomes the heat transmitting fluid 12f from the heat transmitting fluid 12e. The heat transmitting fluid 12a flows toward the heat storage 2 again. Therefore, the heat storage material of this embodiment is heated by radiation heat transmission from the heat generation sources 1a and convection heat transmission from the heat transmitting fluid 12a heated by the heaters 1 and 7. In this way, in the heat storing mode, energy is stored in the heat storage 2 due to the rise in the temperature of the heat storage material in the heat storage 2.

In the heat dissipating mode, the low-temperature heat transmitting fluid 12d flows from the heat exchanger 3a to the outlet 2b of the heat storage 2 via the second heat transferring unit 4b, the flow path switch 5d, and the point Pb, and enters the heat storage 2. In the heat storage 2, the heat of the heat storage material is taken away by the heat transmitting fluid 12d (heat dissipation), and the temperature of the heat storage material decreases. On the other hand, the heat transmitting fluid 12d is increased in temperature to become the high-temperature heat transmitting fluid 12c and is discharged outside the heat storage 2. The heat transmitting fluid 12c flows from the inlet 2a of the heat storage 2 to the flow path switch 5c via the point Pa, and passes through the heat exchanger 3a. At this time, the heat transmitting fluid 12c is decreased in temperature due to heat exchange to return to the low-temperature heat transmitting fluid 12d. This heat transmitting fluid 12d flows again toward the second heat transferring unit 4b. In this way, in the heat dissipating mode, the temperature of the heat storage material decreases by releasing energy from the heat storage material in the heat storage 2.

As described above, the heat storage material of this embodiment is heated by the heater 1 in the heat storage 2 and the heater 7 outside the heat storage 2. Therefore, this embodiment makes it possible to improve the heat transmission efficiency to the heat storage material by combining radiant heat transmission and convection heat transmission using the heaters 1 and 7.

### [B] Details of Heat Storage Power Generation System

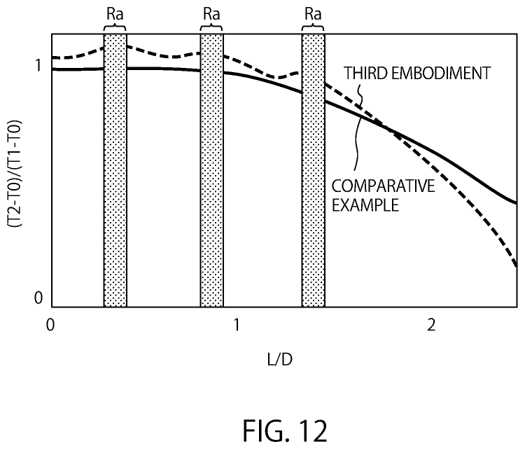

Next, further details of the heat storage power generation system of this embodiment will be described with reference to FIGS. 12-15.

### [B-1] FIG. 12

FIG. 12 is a graph for explaining the operation of the heat storage 2 of the third embodiment.

FIG. 12 shows the temperature distribution in the heat storage material of the heat storage 2 at the time of completion of heat storage. On the vertical axis of FIG. 12, “T0” denotes the initial temperature of the heat storage material, “T1” denotes the set temperature of the heat storage material, and “T2” denotes the temperature at each point in the heat storage material. On the horizontal axis of FIG. 12, “L” denotes a coordinate in the direction (X direction) in which the heat transmitting fluid 12 flows in the heat storage 2, and “D” denotes a representative length of the cross-section of the flow path of the heat storage 2. When T*=(T2−T0)/(T1−T0) and L*=L/D, “T*” denotes the non-dimensionalized temperature at each point in the heat storage material, and “L*” denotes the non-dimensionalized coordinate at each point in the heat storage material. FIG. 12 is a graph showing the relationship between “T*” and “L*” in the heat storage material. The reference numeral Ra indicates a region in which a heat generation source 1a is located in the heat storage material.

FIG. 12 shows the above-described temperature distribution in the heat storage power generation system of a comparative example with a solid line, and shows the above-described temperature distribution in the heat storage power generation system of this embodiment with a dashed line. The heat storage power generation system of this embodiment includes the heater 1 in the heat storage 2 and includes the heater 7 outside the heat storage 2. The heat storage power generation system of the comparative example does not include the heater 1 in the heat storage 2, but includes the heater 7 outside the heat storage 2. In FIG. 12, the heat transmitting fluid 12 of this embodiment and the comparative example is air.

In the comparative example, air (heat transmitting fluid 12) is heated with heat of 17 MW, and the heat storage material is heated by convection heat transmission from this air. Since the inlet 2a (L/D=0) is a portion where the heat of the heat transmitting fluid 12 is first transmitted to the heat storage material, the temperature of the heat storage material rises until it is approximately equal to the temperature of the heat transmitting fluid 12. Since the heat transmitting fluid 12 is deprived of heat by heat exchange with the heat storage material, the amount of heat exchange with the heat storage material decreases as the distance from the inlet 2a increases. As a result, the amount of temperature rise of the heat storage material decreases as the distance from the inlet 2a increases. Therefore, the heat storage material exhibits a temperature distribution in which the vicinity of the inlet 2a becomes high in temperature and the vicinity of the outlet 2b remains at a low temperature. When the heat transmitting fluid 12 continues to be supplied to the heat storage 2, the high temperature region expands from the inlet 2a to the outlet 2b side, so that the average temperature in the heat storage 2 rises. However, it is desirable to maintain the heat transmitting fluid 12 flowing out of the heat storage 2 at as low a temperature as possible. First, this is to prevent an increase in cost, a decrease in durability, and a deterioration in maintainability due to the fact that equipment such as piping, blowers, and dampers connected to the outlet 2b of the heat storage 2 is made of a special material designed for high temperatures. Second, this is because air decreases in density and increases in volume as the temperature increases, and therefore it is necessary to increase the size of the piping and equipment when the air becomes high in temperature. Therefore, it is desirable that the heat storage material around the outlet 2b has a low temperature. Therefore, an operation is performed in which the heat storage operation is stopped when the temperature of the heat storage material or the heat transmitting fluid 12 around the outlet 2b has reached an upper limit temperature. In this case, when the heat storage is completed, the temperature distribution is as shown by the solid line shown in FIG. 12, and the outlet 2b is maintained at a low temperature.

On the other hand, in this embodiment, the air (heat transmitting fluid 12) is heated with heat of 12 MW, and the heat storage material is heated by convection heat transmission from this air. Furthermore, the heat storage material is heated by radiant heat transmission from the heater 1 with heat of 5 MW. At this time, radiant heat due to the heat of the heater 1 heats its surrounding heat storage material not via the heat transmitting fluid 12. However, since the radiant heat heats the heat storage material around the heat generation sources 1a but does not heat the heat storage material in the region where electromagnetic waves do not reach, the temperature rise of the heat storage material due to the radiant heat is local. Therefore, by flowing high-temperature air in the heat storage 2, the radiant heat is also transported downstream and the local temperature rise is relaxed, so that the temperature distribution of the heat storage material is uniformized. As a result, by promoting the temperature rise around the heat generation sources 1a and moderating the temperature rise at a point far from the heat generation sources 1a, it is possible to increase the temperature of the entire heat storage material while leaving a low-temperature region around the outlet 2b as shown by the dashed line shown in FIG. 12. This makes it possible to increase the heat storage density of the heat storage 2 while satisfying temperature constraint conditions of the outlet 2b.

As shown by the reference numeral Ra in FIG. 12, the heat generation sources 1a of this embodiment are disposed closer to the inlet 2a side of the inlet 2a and the outlet 2b in the heat storage 2. If the heat generation sources 1a are evenly disposed in the heat storage 2, the heat storage material at the outlet 2b also becomes high in temperature before sufficient heat is stored in the heat storage material at the inlet 2a desired to be on the high temperature side. As a result, when the heat storage operation is stopped in response to the temperature of the heat storage material on the outlet 2b side becoming a predetermined temperature or higher according to the above operation method, the operation is stopped before sufficient heat is stored in the heat storage 2, so that the amount of stored heat in the heat storage 2 is reduced. As a result, the average temperature of the heat storage material in the heat storage 2 decreases, and sufficient heat storage cannot be performed.

Further, even if heat storage operation is performed until the heat storage material around the inlet 2a desired to be on the high temperature side reaches the required inlet temperature in order to raise the average temperature of the heat storage material in the heat storage 2 to perform sufficient heat storage, the heat storage material around the outlet 2b becomes high in temperature in the same way as the heat storage material around the inlet 2a. Therefore, the heat storage material around the outlet 2b is heated to a temperature higher than the required outlet temperature, and the heat transmitting fluid 12 at the outlet 2b also becomes high in temperature. As a result, it is necessary to design the piping and equipment from the outlet 2b to the heater 1 so as to withstand high temperatures.

According to this embodiment, by disposing the heat generation sources 1a closer to the inlet 2a side, the heat storage material around the inlet 2a is heated to the required inlet temperature even if the heat storage operation is stopped when the heat storage material around the outlet 2b has reached the required outlet temperature. Therefore, the average temperature of the heat storage material in the heat storage 2 can be increased.

Further, even when the heat storage material around the inlet 2a desired to be on the high temperature side has reached the required inlet temperature and sufficient heat is stored in the heat storage material, the heat storage material around the outlet 2b can be suppressed to a lower temperature than the required outlet temperature. Therefore, it is not necessary to design the piping and equipment from the outlet 2b to the heater 1 so as to withstand high temperatures, and it is possible to suppress the problem when the heat storage 2 is heated evenly.

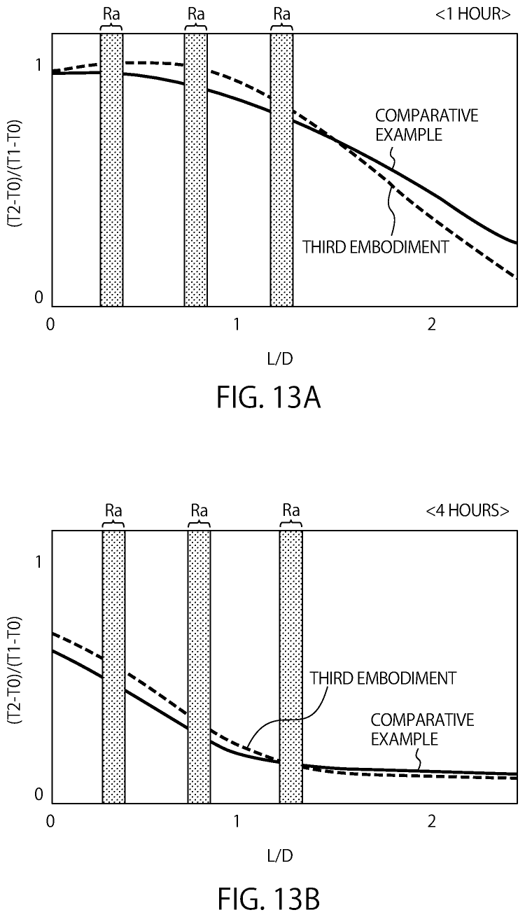

### [B-2] FIGS. 13A and 13B

FIGS. 13A and 13B are other graphs for explaining operation of the heat storage 2 of the third embodiment.

FIGS. 13A and 13B are graphs similar to that of FIG. 12. FIG. 13A shows the temperature distribution one hour after the start of heat dissipation. FIG. 13B shows the temperature distribution four hours after the start of heat dissipation.

In the heat dissipating mode, low-temperature air (heat transmitting fluid 12) is supplied into the heat storage 2 through the outlet 2b, becomes high in temperature by heat exchange with the high-temperature heat storage material, and is discharged from the heat storage 2 through the inlet 2a. In the comparative example shown in FIGS. 13A and 13B, when the heat dissipation operation is continued, the heat of the heat storage material is gradually taken away from the outlet 2b side of the heat storage 2 (the right side of FIGS. 13A and 13B), so that the overall temperature of the heat storage material decreases. The lower the discharged air temperature, the lower the efficiency of the heat exchanger 3a, and therefore it is desirable that the heat storage material is maintained at as high a temperature as possible for a long time. Since the amount of stored heat at the time of completion of heat storage is large (FIG. 12), this embodiment shown in FIGS. 13A and 13B makes it possible to maintain a higher discharged air temperature.

The heater 1 of this embodiment may be installed around the outlet 2b in the heat storage 2. This makes it possible to increase the amount of stored heat energy of the heat storage material around the outlet 2b, and makes it possible to maintain a higher discharged air temperature in the heat dissipating mode.

Since the heater 1 of this embodiment can heat the heat storage material by radiant heat transmission, the required heating wire temperature is low and the heat transmission loss is less than that of convection heat transmission. This makes it possible to reduce the required capacity (kWh) and output (KW) of the heater 1. Further, since the heater 1 of this embodiment is disposed in the heat storage 2, the required capacity can be achieved with a small structure compared to the case where it is disposed outside the heat storage 2. This makes it possible to reduce the cost and size of the heat storage power generation system.

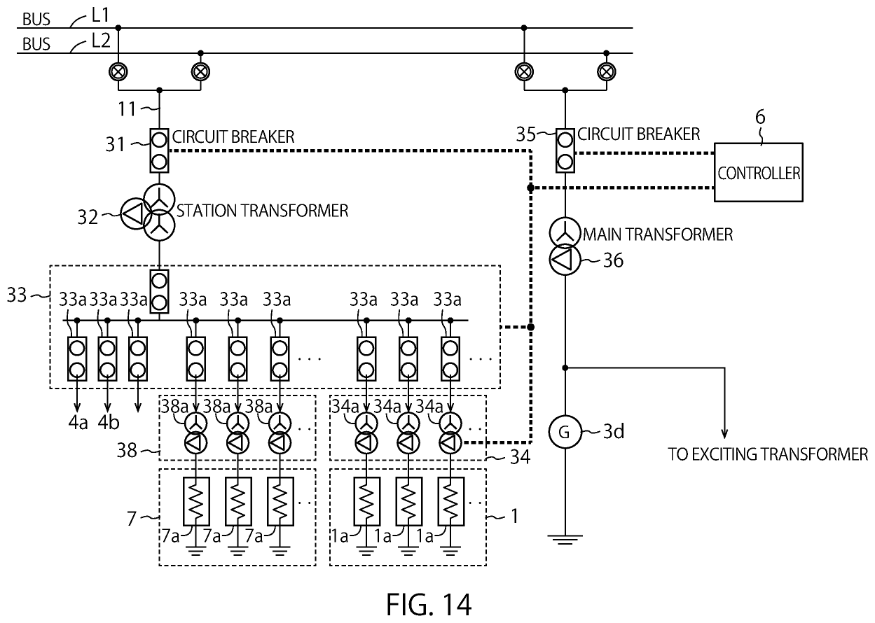

### [B-3] FIG. 14

FIG. 14 is a diagram showing an example configuration of the electric circuit of the heat storage power generation system of the third embodiment.

The electric circuit shown in FIG. 14 includes a power distributing unit 38 for the heater 7 in addition to the components shown in FIG. 8. The power distributing unit 38 includes a plurality of transformers 38a, similar to the power distributing unit 34. Each heat generation source 7a in the heater 7 is connected to the electric circuit switcher 33a in the power distributing unit 33 via the transformer 38a in the power distributing unit 38.

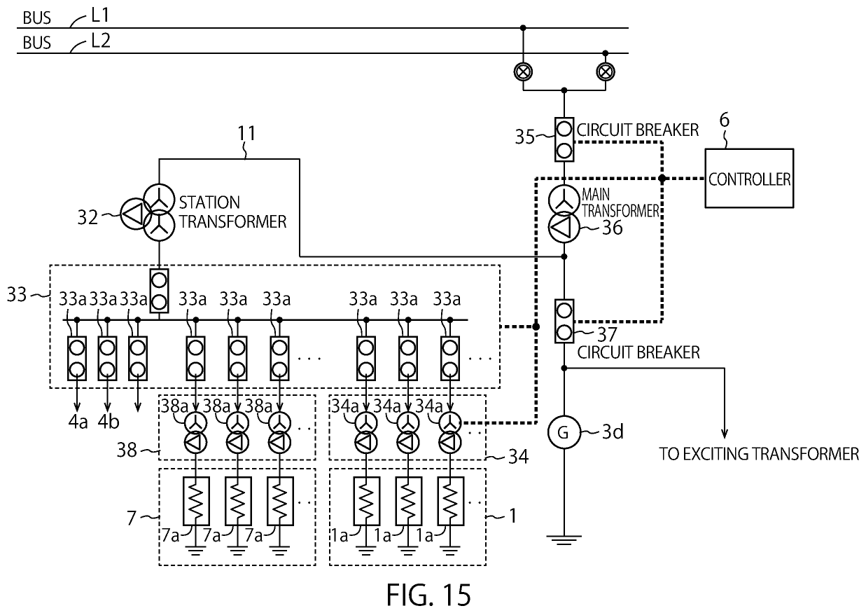

### [B-4] FIG. 15

FIG. 15 is a diagram showing another example configuration of the electrical circuit of the heat storage power generation system of the third embodiment.

The electric circuit shown in FIG. 15 includes the power distributing unit 38 for the heater 7 in addition to the components shown in FIG. 9. The power distributing unit 38 includes a plurality of transformers 38a, similar to the power distributing unit 34. Each heat generation source 7a in the heater 7 is connected to the electric circuit switcher 33a in the power distributing unit 33 via the transformer 38a in the power distributing unit 38.

As described above, the heat storage material of this embodiment is heated by the heater 1 in the heat storage 2 and the heater 7 outside the heat storage 2. Therefore, this embodiment makes it possible to realize the heaters 1 and 7 and the heat storage 2 having a suitable structure, for example, makes it possible to improve the heat transmission efficiency to the heat storage material by combining radiant heat transmission and convection heat transmission using the heaters 1 and 7.

The contents described with reference to FIGS. 2A and 2B to 7 can also be applied to the heat storage power generation system of this embodiment.

### Fourth Embodiment

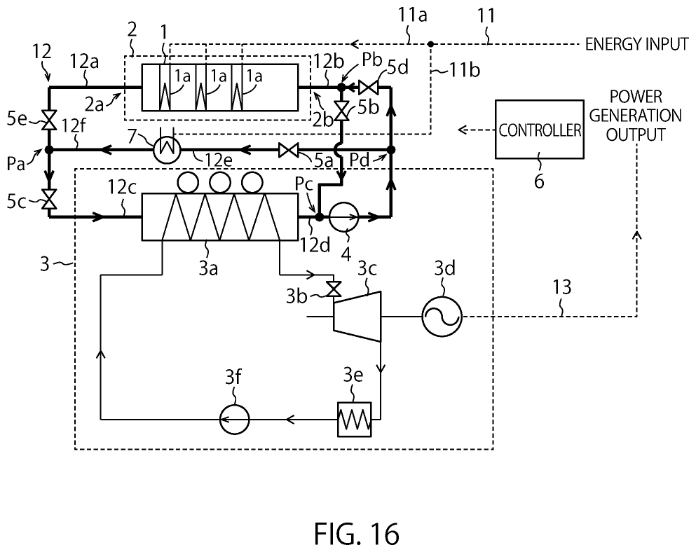

FIG. 16 is a schematic diagram showing a configuration of a heat storage power generation system of a fourth embodiment.

The heat storage power generation system of this embodiment has a configuration that combines the heat storage power generation system of the second embodiment and the heat storage power generation system of the third embodiment. Therefore, the heat storage power generation system of this embodiment includes the heat transferring unit 4 instead of the first heat transferring unit 4a and the second heat transferring unit 4b, includes the flow path switch 5e in addition to the flow path switches 5a-5d, and includes the heater 7 in addition to the heater 1. FIG. 16 shows the points Pc and Pd in addition to the points Pa and Pb.

In the heat storing mode, the heat transmitting fluid 12 circulates in the flow path between the heat transferring unit 4, the point Pd, the flow path switch 5a, the heater 7, the point Pa, the flow path switch 5e, the heat storage 2, the point Pb, the flow path switch 5b, and the point Pc. At this time, the flow path switches 5a, 5b, and 5e are in an open state, and the flow path switches 5c and 5d are in a closed state.

In the heat dissipating mode, the heat transmitting fluid 12 circulates in the flow path between the heat transferring unit 4, the point Pd, the flow path switch 5d, the point Pb, the heat storage 2, the flow path switch 5e, the point Pa, the flow path switch 5c, the heat exchanger 3a, and the point Pc. At this time, the flow path switches 5c, 5d, and 5e are in an open state, and the flow path switches 5a and 5b are in a closed state.

FIG. 16 further shows the heat transmitting fluids 12e and 12f in addition to the heat transmitting fluids 12a-12d as the heat transmitting fluid 12. Hereinafter, the flow of the heat transmitting fluid 12 in the heat storing mode and the heat dissipating mode will be described focusing on the heat transmitting fluids 12a-12f.

In the heat storing mode, the heat transmitting fluid 12a flows from the flow path switch 5e to the inlet 2a of the heat storage 2 and enters the heat storage 2. In the heat storage 2, the heat storage material is heated by radiation heat transmission from the heat generation sources 1a and convection heat transmission from the heat transmitting fluid 12a, so that the temperature of the heat storage material rises. The heat transmitting fluid 12a, after its temperature has changed in the heat storage 2, becomes the heat transmitting fluid 12b and is discharged outside the heat storage 2. The heat transmitting fluid 12b flows from the outlet 2b of the heat storage 2 to the point Pc via the point Pb and the flow path switch 5b, and passes through the heat transferring unit 4, the point Pd, the flow path switch 5a, and the heater 7 in order. FIG. 16 represents the heat transmitting fluid 12 flowing from the heat storage 2 to the flow path switch 5a as “heat transmitting fluid 12b”, represents the heat transmitting fluid 12 flowing from the flow path switch 5a to the heater 7 as “heat transmitting fluid 12e”, represents the heat transmitting fluid 12 flowing from the heater 7 to the flow path switch 5e as “heat transmitting fluid 12f”, and represents the heat transmitting fluid 12 flowing from the flow path switch 5e to the heat storage 2 as “heat transmitting fluid 12a”. This heat transmitting fluid 12 is heated when it passes through the heater 7, that is, when it becomes the heat transmitting fluid 12f from the heat transmitting fluid 12e. The heat transmitting fluid 12a flows toward the heat storage 2 again. Therefore, the heat storage material of this embodiment is heated by radiation heat transmission from the heat generation sources 1a and convection heat transmission from the heat transmitting fluid 12a heated by the heaters 1 and 7. In this way, in the heat storing mode, energy is stored in the heat storage 2 due to the rise in the temperature of the heat storage material in the heat storage 2.

In the heat dissipating mode, the low-temperature heat transmitting fluid 12d flows from the heat exchanger 3a to the outlet 2b of the heat storage 2 via the point Pc, the heat transferring unit 4, the point Pd, the flow path switch 5d, and the point Pb, and enters the heat storage 2. In the heat storage 2, the heat of the heat storage material is taken away by the heat transmitting fluid 12d (heat dissipation), and the temperature of the heat storage material decreases. On the other hand, the heat transmitting fluid 12d is increased in temperature to become the high-temperature heat transmitting fluid 12c and is discharged outside the heat storage 2. The heat transmitting fluid 12c flows from the inlet 2a of the heat storage 2 to the flow path switch 5c via the flow path switch 5e and the point Pa, and passes through the heat exchanger 3a. At this time, the heat transmitting fluid 12c is decreased in temperature due to heat exchange to return to the low-temperature heat transmitting fluid 12d. This heat transmitting fluid 12d flows again toward the heat transferring unit 4 via the point Pc. In this way, in the heat dissipating mode, the temperature of the heat storage material decreases by releasing energy from the heat storage material in the heat storage 2.

As described above, the heat storage material of this embodiment is heated by the heater 1 in the heat storage 2 and the heater 7 outside the heat storage 2. Therefore, this embodiment makes it possible to realize the heaters 1 and 7 and the heat storage 2 having a suitable structure, for example, makes it possible to improve the heat transmission efficiency to the heat storage material by combining radiant heat transmission and convection heat transmission using the heaters 1 and 7.

Further, the heat storage power generation system of this embodiment includes the heat transferring unit 4 instead of the first heat transferring unit 4a and the second heat transferring unit 4b. Therefore, this embodiment makes it possible to reduce the number of heat transferring units provided in the heat storage power generation system.

The contents described with reference to FIGS. 2A and 2B to 7 and FIGS. 12 to 15 can also be applied to the heat storage power generation system of this embodiment. However, the electric circuit switchers 33a in the power distributing unit 33 shown in FIG. 14 are connected to the heat transferring unit 4 instead of the first heat transferring unit 4a and the second heat transferring unit 4b. The same applies to the electric circuit switchers 33a in the power distributing unit 33 shown in FIG. 15.

### Fifth Embodiment

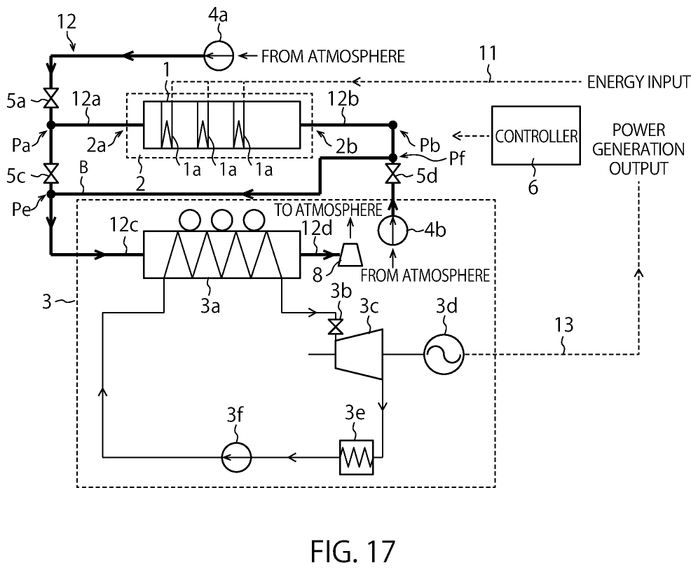

FIG. 17 is a schematic diagram showing a configuration of a heat storage power generation system of a fifth embodiment.

The heat storage power generation system of this embodiment includes components similar to those of the heat storage power generation system of the first embodiment. However, the heat storage power generation system of this embodiment does not include the flow path switch 5b but includes a chimney 8. The operation of the chimney 8 is also controlled by the controller 6. FIG. 17 shows points Pe and Pf in addition to the points Pa and Pb, and shows a bypass flow path B.

The point Pe is located between the flow path switch 5c and the heat exchanger 3a. The point Pf is located between the flow path switch 5d and the point Pb. The bypass flow path B is provided between the point Pe and the point Pf.

The first heat transferring unit 4a of this embodiment supplies the heat transmitting fluid 12 taken in from the atmosphere to the flow path switch 5a, and the second heat transferring unit 4b of this embodiment supplies the heat transmitting fluid 12 taken in from the atmosphere to the flow path switch 5d. On the other hand, the heat transmitting fluid 12 discharged from the heat exchanger 3a of this embodiment flows into the chimney 8 and is emitted from the chimney 8 into the atmosphere. In this way, the heat transmitting fluid 12 of this embodiment flows so as not to circulate in the heat storage power generation system. The heat transmitting fluid 12 of this embodiment is air.

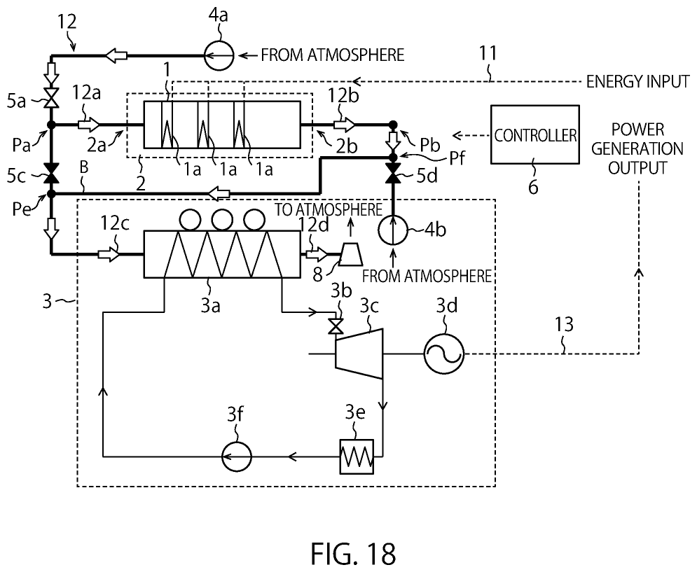

FIG. 18 is a schematic diagram for explaining the heat storing mode of the fifth embodiment.

FIG. 18 shows the flow route of the heat transmitting fluid 12 in the heat storing mode with arrows. In the heat storing mode of this embodiment, the flow path switch 5a is in an open state, and the flow path switches 5c and 5d are in a closed state.

In the heat storing mode of this embodiment, the heat transmitting fluid 12 is taken in from the atmosphere by the first heat transferring unit 4a. This heat transmitting fluid 12 passes through the flow path switch 5a, the point Pa, the heat storage 2, the point Pb, the point Pf, the bypass flow path B, the point Pe, and the heat exchanger 3a in order, and is emitted from the chimney 8 into the atmosphere.

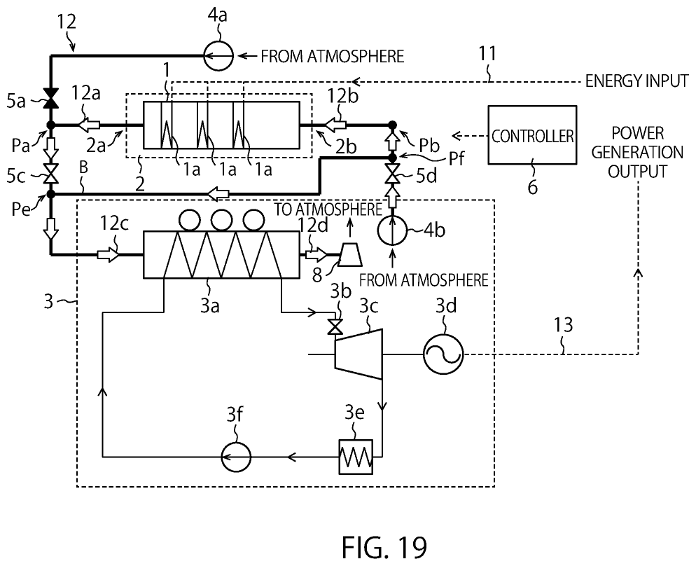

FIG. 19 is a schematic diagram for explaining the heat dissipating mode of the fifth embodiment.

FIG. 19 shows the flow route of the heat transmitting fluid 12 in the heat dissipating mode with arrows. In the heat dissipating mode of this embodiment, the flow path switches 5c and 5d are in an open state, and the flow path switch 5a is in a closed state.

In the heat dissipating mode of this embodiment, the heat transmitting fluid 12 is taken in from the atmosphere by the second heat transferring unit 4b. This heat transmitting fluid 12 passes through the flow path switch 5d, the point Pf, the point Pb, the heat storage 2, the point Pa, the flow path switch 5c, the point Pe, and the heat exchanger 3a in order, and is emitted from the chimney 8 into the atmosphere. A part of this heat transmitting fluid 12 passes through the bypass flow path B instead of passing through the point Pb, the heat storage 2, the point Pa, and the flow path switch 5c.

As described above, the heat transmitting fluid 12 of this embodiment flows so as not to circulate in the heat storage power generation system. Therefore, since the high-temperature heat transmitting fluid 12 does not circulate in the heat storage power generation system, this embodiment makes it possible to suppress the deterioration of equipment and piping in the heat storage power generation system due to the high-temperature heat transmitting fluid 12. The heat storage power generation system of this embodiment may further include the heater 7 of the third or fourth embodiment.

### Sixth Embodiment

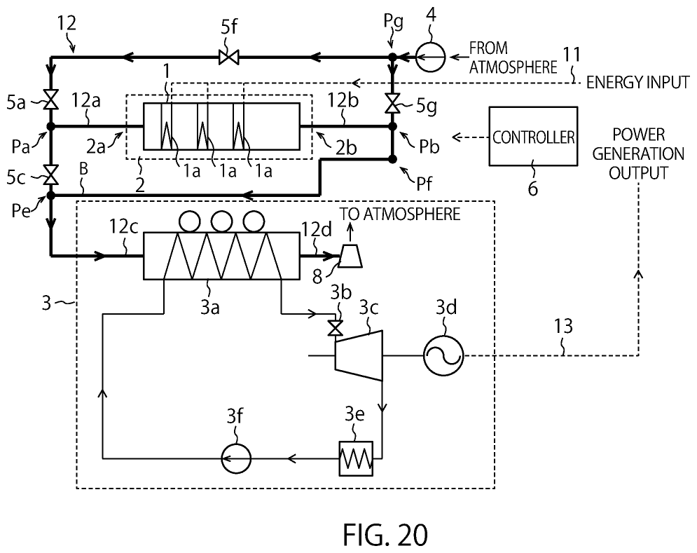

FIG. 20 is a schematic diagram showing a configuration of a heat storage power generation system of a sixth embodiment.

The heat storage power generation system of this embodiment includes components similar to those of the heat storage power generation system of the first embodiment. However, the heat storage power generation system of this embodiment includes the heat transferring unit 4 instead of the first heat transferring unit 4a and the second heat transferring unit 4b, includes flow path switches 5f and 5g instead of the flow path switches 5b and 5d, and further includes the chimney 8. The operation of the heat transferring unit 4, the flow path switches 5f and 5g, and the chimney 8 are also controlled by the controller 6. FIG. 20 shows points Pe, Pf, and Pg in addition to the points Pa and Pb, and shows the bypass flow path B.

The point Pe is located between the flow path switch 5c and the heat exchanger 3a. The point Pf is located between the point Pb and the point Pe. The flow path switch 5g, the point Pg, and the flow path switch 5f are located in order between the point Pb and the flow path switch 5a. The bypass flow path B is provided between the point Pe and the point Pf.

The heat transferring unit 4 of this embodiment supplies the heat transmitting fluid 12 taken in from the atmosphere to the point Pg. On the other hand, the heat transmitting fluid 12 discharged from the heat exchanger 3a of this embodiment flows into the chimney 8 and is emitted from the chimney 8 into the atmosphere. In this way, the heat transmitting fluid 12 of this embodiment flows so as not to circulate in the heat storage power generation system. The heat transmitting fluid 12 of this embodiment is air.

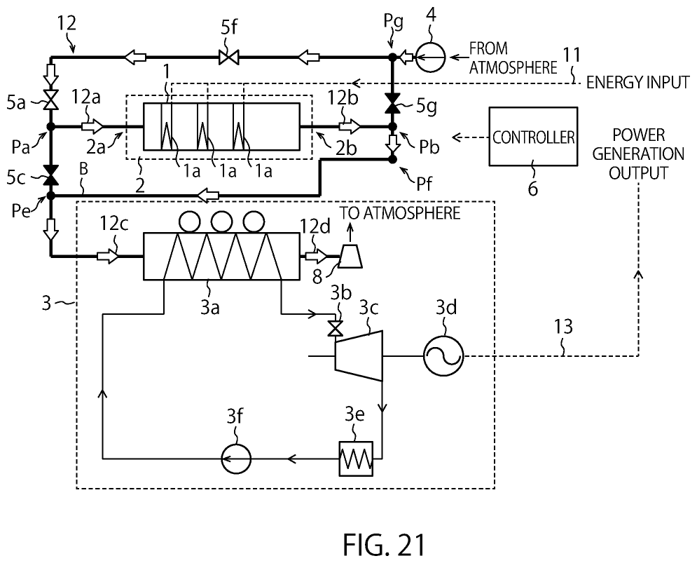

FIG. 21 is a schematic diagram for explaining the heat storing mode of the sixth embodiment.

FIG. 21 shows the flow route of the heat transmitting fluid 12 in the heat storing mode with arrows. In the heat storing mode of this embodiment, the flow path switches 5a and 5f are in an open state, and the flow path switches 5c and 5g are in a closed state.

In the heat storing mode of this embodiment, the heat transmitting fluid 12 is taken in from the atmosphere by the heat transferring unit 4. This heat transmitting fluid 12 passes through the point Pg, the flow path switch 5f, the flow path switch 5a, the point Pa, the heat storage 2, the point Pb, the point Pf, the bypass flow path B, the point Pe, and the heat exchanger 3a in order, and is emitted from the chimney 8 into the atmosphere.

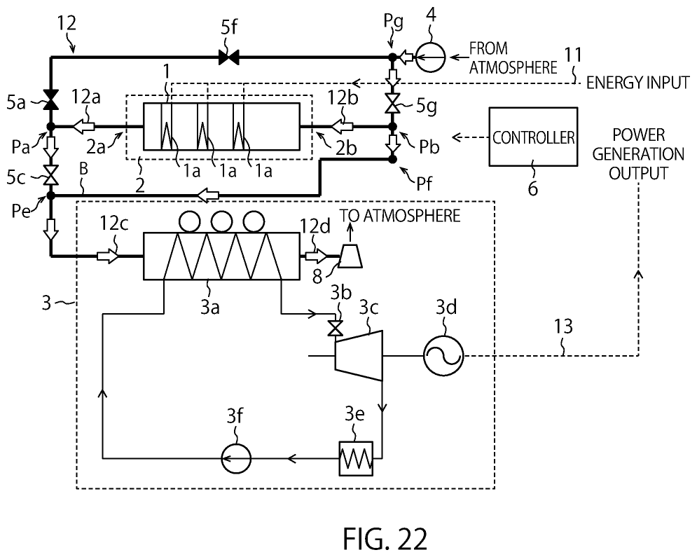

FIG. 22 is a schematic diagram for explaining the heat dissipating mode of the sixth embodiment.

FIG. 22 shows the flow route of the heat transmitting fluid 12 in the heat dissipating mode with arrows. In the heat dissipating mode of this embodiment, the flow path switches 5c and 5g are in an open state, and the flow path switches 5a and 5f are in a closed state.

In the heat dissipating mode of this embodiment, the heat transmitting fluid 12 is taken in from the atmosphere by the heat transferring unit 4. This heat transmitting fluid 12 passes through the point Pg, the flow path switch 5g, the point Pb, the heat storage 2, the point Pa, the flow path switch 5c, the point Pe, and the heat exchanger 3a in order, and is emitted from the chimney 8 into the atmosphere. A part of this heat transmitting fluid 12 passes through the point Pf and the bypass flow path B instead of passing through the heat storage 2, the point Pa, and the flow path switch 5c.

As described above, the heat transmitting fluid 12 of this embodiment flows so as not to circulate in the heat storage power generation system. Therefore, since the high-temperature heat transmitting fluid 12 does not circulate in the heat storage power generation system, this embodiment makes it possible to suppress the deterioration of equipment and piping in the heat storage power generation system due to the high-temperature heat transmitting fluid 12. The heat storage power generation system of this embodiment may further include the heater 7 of the third or fourth embodiment.

While certain embodiments have been described, these embodiments have been presented by way of example only, and are not intended to limit the scope of the inventions. Indeed, the novel systems and apparatuses described herein may be embodied in a variety of other forms; furthermore, various omissions, substitutions and changes in the form of the systems and apparatuses described herein may be made without departing from the spirit of the inventions. The accompanying claims and their equivalents are intended to cover such forms or modifications as would fall within the scope and spirit of the inventions.

1. A heat storage power generation system comprising:
a heat storage including a heat storage material that stores heat, and configured to heat a heat transmitting fluid by the heat stored in the heat storage material;
a first heater provided in the heat storage, and configured to heat the heat storage material; and
a power generator configured to generate power using the heat transmitting fluid heated by the heat storage,
wherein
the heat storage includes an inlet to which the heat transmitting fluid is supplied when storing the heat in the heat storage material, and an outlet that discharges the heat transmitting fluid when storing the heat in the heat storage material, and
the first heater includes one or more heat generation sources disposed closer to an inlet side of the inlet and the outlet, and heats the heat storage material by heat generated from the heat generation sources.

2. The system of claim 1, wherein the first heater heats the heat storage material by at least radiant heat transmission.

3. The system of claim 1, further comprising a second heater provided outside the heat storage, and configured to heat the heat transmitting fluid to supply the heat transmitting fluid to the heat storage.

4. The system of claim 3, wherein the second heater heats the heat storage material by at least convection heat transmission.

5. The system of claim 1, further comprising:
a first heat transferring unit configured to convey the heat transmitting fluid when heating the heat storage material by the first heater; and
a second heat transferring unit configured to convey the heat transmitting fluid when generating the power by the power generator.

6. The system of claim 1, further comprising a heat transferring unit configured to convey the heat transmitting fluid when heating the heat storage material by the first heater and when generating the power by the power generator.

7. The system of claim 1, further comprising:
a first flow path switch configured to enter an open state when heating the heat storage material by the first heater, to allow passage of the heat transmitting fluid; and
a second flow path switch configured to enter an open state when generating the power by the power generator, to allow passage of the heat transmitting fluid.

8. The system of claim 1, wherein at least one of the one or more heat generation sources has a shape extending perpendicular or parallel to a conveying direction of the heat transmitting fluid.

9. The system of claim 1, wherein at least one of the one or more heat generation sources is sandwiched between a first frame and a second frame.

10. The system of claim 1, wherein
the heat storage includes a container having a plurality of openings in a planar view, and
the plurality of openings contain the first heater.

11. The system of claim 10, wherein the plurality of openings further contain the heat storage material.

12. The system of claim 10, wherein the container has a honeycomb structure in which shapes of the plurality of openings are hexagonal in a planar view.

13. The system of claim 1, wherein the heat storage is newly installed in the heat storage power generation system, the first heater is newly installed in the heat storage power generation system, and the power generator is originally installed in the heat storage power generation system.

14. The system of claim 1, wherein the heat transmitting fluid flows so as not to circulate in the heat storage power generation system.

15. A heat storage apparatus comprising:
a heat storage including a heat storage material that stores heat, and configured to heat a heat transmitting fluid by the heat stored in the heat storage material; and
a first heater provided in the heat storage, and configured to heat the heat storage material,
wherein
the heat storage includes an inlet to which the heat transmitting fluid is supplied when storing heat in the heat storage material, and an outlet that discharges the heat transmitting fluid when storing heat in the heat storage material, and
the first heater includes one or more heat generation sources disposed closer to an inlet side of the inlet and the outlet, and heats the heat storage material by heat generated from the heat generation sources.
